(19) United States
(12) Patent Application Publication
(10) Pub. No.: US 2023/0061808 A1
(43) Pub. Date: Mar. 2, 2023

(54) Distributed Machine-Learned Models Across Networks of Interactive Objects

(71) Applicant: Google LLC, Mountain View, CA (US)

(72) Inventor: Nicholas Gillian, Palo Alto, CA (US)

(21) Appl. No.: 17/790,418

(22) PCT Filed: Dec. 30, 2019
(86) PCT No.: PCT/US2019/068928

§ 371 Date: Jun. 30, 2022

(51) Int. Cl. G06N 5/04

(52) U.S. Cl. CPC G06N 5/04

(57) ABSTRACT

A set of interactive objects can implement a machine-learned model for monitoring an activity while communicatively coupled over one or more networks. The machine-learned model can be configured to generate data indicative of at least one inference associated with the activity based at least in part on sensor data associated with two or more interactive objects of the set of interactive objects. The computing system can determine for each interactive object a respective portion of the machine-learned model for execution by the interactive object during at least a portion of the activity. The computing system can generate for each interactive object configuration data indicative of the respective portion of the machine-learned model for execution by the interactive object during the portion of the activity. The computing system can communicate the configuration data indicative of the respective portion of the machine-learned model for execution by to each interactive object.

### FIELD

The present disclosure relates generally to machine-learned models for generating inferences based on sensor data.

### BACKGROUND

Detecting gestures, motions, and other user attributes using interactive objects such as wearable devices that include limited computational resources (e.g., processing capabilities, memory, etc.) can present a number of unique considerations. Machine-learned models are often used as part of gesture detection and other user attribute recognition processes that are based on input sensor data. Sensor data such as touch data generated in response to touch input, motion data generated in response to user motion, or physiological data generated in response to user physiological conditions can be input to one or more machine-learned models. The machine-learned models can be trained to generate one or more inferences based on the input sensor data. These inferences can include detections, classifications, and/or predictions of gestures, movements, or other user classifications. By way of example, a machine-learned model may be used to determine if input sensor data corresponds to a swipe gesture or other intended user input.

Traditionally, machine-learned models have been deployed at edge device(s) including client devices where the sensor data is generated, or at remote computing devices such as server computer systems that have a larger number of computational resources compared with the edge devices. Deploying a machine-learned model at an edge device has the benefit that raw sensor data is not required to be transmitted from the edge device to a remote computing device for processing. However, edge devices often have limited computational resources that may be inadequate for deploying complex machine-learned models. Additionally, edge devices may have limited power supplies that may be insufficient to support large processing operations while also providing a useful device. Deploying a machine-learned model at a remote computing device with additional processing capabilities than those provided by the edge computing device can seem a logical solution in many cases. However, using a machine-learned model at a remote computing device may require transmitting sensor data from the edge device to the one or more remote computing devices. Such configurations can lead to privacy concerns associated with transmitting user data from the edge device, as well as bandwidth considerations relating to the amount of raw sensor data that can be transmitted.

### SUMMARY

Aspects and advantages of embodiments of the present disclosure will be set forth in part in the following description, or may be learned from the description, or may be learned through practice of the embodiments.

One example aspect of the present disclosure is directed to a computer-implemented method performed by at least one computing device of a computing system. The method includes identifying a set of interactive objects to implement a machine-learned model for monitoring an activity while communicatively coupled over one or more networks. Each interactive object includes at least one respective sensor configured to generate sensor data associated with such interactive object. The machine-learned model is configured to generate data indicative of at least one inference associated with the activity based at least in part on sensor data associated with two or more interactive objects of the set of interactive objects. The method includes determining, for each interactive object of the set of interactive objects, a respective portion of the machine-learned model for execution by such interactive object during at least a portion of the activity, generating, for each interactive object, configuration data indicative of the respective portion of the machine-learned model for execution by such interactive object during at least the portion of the activity, and communicating, to each interactive object of the set of interactive objects, the configuration data indicative of the respective portion of the machine-learned model for execution by such interactive object.

Another example aspect of the present disclosure is directed to a computing system that includes one or more processors and one or more non-transitory computer-readable media that collectively store instructions that when executed by the one or more processors cause the one or more processors to perform operations. The operations include identifying a set of interactive objects to implement a machine-learned model for monitoring an activity while communicatively coupled over one or more networks. Each interactive object includes at least one respective sensor configured to generate sensor data associated with such interactive object. The machine-learned model configured to generate data indicative of at least one inference associated with the activity based at least in part on sensor data associated with two or more interactive objects of the set of interactive objects. The operations include determining for each interactive object of the set of interactive objects a respective portion of the machine-learned model for execution by such interactive object during at least a portion of the activity, generating for each interactive object configuration data indicative of the respective portion of the machine-learned model for execution by such interactive object during at least the portion of the activity, and communicating to each interactive object of the set of interactive objects the configuration data indicative of the respective portion of the machine-learned model for execution by such interactive object.

Yet another example aspect of the present disclosure is directed to an interactive object including one or more sensors configured to generate sensor data associated with a user of the interactive object and one or more processors communicatively coupled to the one or more sensors. The one or more processors are configured to obtain first configuration data indicative of a first portion of a machine-learned model configured to generate data indicative of at least one inference associated with an activity monitored by a set of interactive objects including the interactive object. The set of interactive objects are communicatively coupled over one or more networks and each interactive object stores at least a portion of the machine-learned model during at least a portion of a time period associated with the activity. The one or more processors are configured to configure, in response to the first configuration data, the interactive object to generate a first set of feature representations based at least in part on the first portion of the machine-learned model and sensor data associated with the one or more sensors of the interactive object. The one or more processors are configured to obtain, by the interactive object subsequent to generating the first set of feature representations, second configuration data indicative of a second portion of the machine-learned model, and configure, in response to the second configuration data, the interactive object to generate a second set of feature representations based at least in part on the second portion of the machine-learned model and sensor data associated with the one or more sensors of the interactive object.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts a block diagram of an example computing environment in which a machine-learned model in accordance with example embodiments of the present disclosure may be implemented.;

FIG. 2 depicts a block diagram of an example computing environment that includes an interactive object in accordance with example embodiments of the present disclosure;

FIG. 3 depicts an example of a touch sensor in accordance with example embodiments of the present disclosure;

FIG. 4 depicts an example of a computing environment including distributed machine-learned processing under the control of a model distribution manager in accordance with example embodiments of the present disclosure;

FIG. 5 depicts an example of a computing environment including a set of interactive objects that execute a machine-learned model in order to detect movements based on sensor data associated with users during an activity in accordance with example embodiments of the present disclosure;

FIG. 6 depicts a flowchart describing an example method of allocating machine-learned processing amongst the set of interactive objects in accordance with example embodiments of the present disclosure;

FIG. 7 depicts an example of a computing environment including a set of interactive objects that execute a machine-learned model in order to detect movements based on sensor data associated with users during an activity in accordance with example embodiments of the present disclosure;

FIG. 8 depicts an example of a computing environment including a set of interactive objects that execute a machine-learned model in order to detect movements based on sensor data associated with users during an activity in accordance with example embodiments of the present disclosure;

FIG. 9 depicts a flowchart describing an example method of configuring an interactive object in response to configuration data associated with the machine-learned model in accordance with example embodiments of the present disclosure;

FIG. 10 depicts a flowchart describing an example method of machine-learned processing by an interactive object in accordance with example embodiments of the present disclosure;

FIG. 11 depicts a block diagram of an example computing system for training and deploying a machine-learned model in accordance with example embodiments of the present disclosure;

FIG. 12 depicts a block diagram of an example computing device that can be used to implement example embodiments in accordance with the present disclosure; and

FIG. 13 depicts a block diagram of an example computing device that can be used to implement example embodiments in accordance with the present disclosure.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Generally, the present disclosure is directed to systems and methods for dynamically configuring machine-learned models that are distributed across a plurality of interactive objects such as wearable devices in order to detect complex user movements or other user attributes. More particularly, embodiments in accordance with the present disclosure are directed to techniques for dynamically allocating machine-learned execution among a group of interactive objects based on resource attributes associated with the interactive objects. By way of example, a computing system in accordance with example embodiments can determine that a set of interactive objects is to implement a machine-learned model in order to monitor an activity. In response, the computing system can dynamically distribute individual portions of the machine-learned model for execution by individual interactive objects during the activity. In some examples, the computing system can obtain data indicative of resources available or predicted to be available to the individual interactive objects during the activity. Based on resource attribute data indicative of such resource states, such as processing cycles, memory, power, bandwidth, etc., the computing system can assign execution of individual portions of the machine-learned model to certain wearable devices. The computing system can monitor the resources available to the interactive objects during the activity. In response to detecting changes in resource availability, the computing system can dynamically redistribute execution of portions of the machine-learned model among the interactive objects. By dynamically distributing and redistributing machine-learned processing among interactive objects based on their resource capabilities during an activity, computing systems in accordance with example embodiments can adapt to resource variability often associated with lightweight computing devices such as interactive objects. For instance, a user may take a break from an activity which can result in increased availability of computational resources in response to the reduced movement by the user. In accordance with some aspects of the present disclosure, a computing system can respond by re-allocating additional machine-learned processing to such an interactive object.

By way of example, a set of interactive objects may each be configured with at least a respective portion of a machine-learned model that generates inferences in association with a user (e.g., movement detection, stress detection, etc.) during an activity such as a sporting event (e.g., soccer, basketball, football, etc.). For instance, a plurality of users (e.g., players, coaches, referees etc.) can each wear or otherwise have disposed on their person an interactive object such as a wearable device that is equipped with one or more sensors and processing circuitry (e.g., microprocessor, application-specific integrated circuit, etc.). Additionally or alternatively, interactive objects not associated with an individual may be used. For instance, a piece of sporting equipment such as a ball, goal, portion of a field, etc. may include or otherwise form an interactive object by the incorporation of one or more sensors and processing circuitry. The one or more sensors can generate sensor data indicative of user movements and the processing circuitry can process the sensor data, alone or in combination with other processing circuitry and/or sensor data, to generate inferences associated with user movements. Multiple interactive objects may be utilized in order to generate an inference associated with the user movement.

A machine-learned model in accordance with example embodiments can be dynamically distributed and re-distributed amongst the multiple interactive objects to generate inferences based on the combined sensor data of the multiple objects. It is noted that the dynamically distribute model can include a single machine-learned model that is distributed across the set interactive objects such that together, the individual portions of the model combine to generate inferences associated with multiple objects. Different functions of the model can be performed at different interactive objects. In this respect, the portions at each interactive object are not individual instances or copies of the same model that perform the same function at each interactive object. Instead, the model has different functions distributed across the different interactive objects such that the model generates inferences in association with combinations of sensor data at multiple ones of the interactive objects.

A machine-learned model can be configured to generate inferences based on combinations of sensor data from multiple interactive objects. For instance, a machine-learned classifier may be used to detect passes between players based on the sensor data generated by an inertial measurement unit of the wearable devices worn by the players. As another example, a classification model can be configured to classify a user movement including a basketball shot that includes both a jump motion and an arm motion. A first interactive object may be disposed at a first location on the user to detect jump motions while a second interactive object may be disposed a second location on the user to detecting arm motions. Together, a machine-learned classifier can utilize the outputs of the sensors to determine whether a shot has occurred. In accordance with example embodiments of the disclosed technology, processing of the sensor data from the two interactive objects by the machine-learned classification model can be dynamically allocated amongst the interactive objects and/or other computing devices based on parameters such as resource attributes associated with the individual devices. For instance, if the first interactive object has greater resource capability (e.g., more power availability, more bandwidth, and/or more computational resources, etc.) than the second interactive object at a particular time during the activity, execution of a larger portion of the machine-learned model can be allocated to the first interactive object. If at a later time the second interactive object has greater resource capability, execution of a larger portion of the machine-learned model can be allocated to the second interactive object. The allocation of machine-learned processing to the various interactive objects can include transmitting configuration data to the interactive objects. The configuration data can include data indicative of portions of the distributed machine-learned model to be executed by the interactive object and/or identifying information of sources of data to be used for such processing. For instance, the configuration data may identify the location of other computing nodes (e.g., other wearable devices) to which intermediate feature representations and/or inferences should be transmitted or from which such data should be received. In other examples, the configuration data can include portions of the machine-learned model itself. The interactive object can configure one or more portions of the machine-learned model based on the configuration data. For example, the interactive object can determine layers of the model to be executed locally, the identification of other computing devices that will provide inputs, and the identification of other computing devices that are to receive outputs. In this manner, the internal propagation of feature representations within a machine-learned model can be modified based on the configuration data. Because machine-learned models are inherently causal systems such that data generally propagates in a defined direction, the model distribution manager can manage the model so that appropriate data flows remain. For instance, the input and output locations can be redefined as processing is reallocated so that a particular interactive object receives feature representations from an appropriate interactive object and provides its generated feature representations to an appropriate interactive object.

According to example aspects of the present disclosure, distributed processing of a machine-learned model can be initially allocated, such as at the beginning or prior to the commencement of an activity. For instance, a model distribution manager can be configured at one or more computing devices. The model distribution manager can initially allocate processing of a machine-learned model amongst a set of wearable devices. The model distribution manager can identify one or more machine-learned models to be used to generate inferences associated with the activity and can determine a set of interactive objects that are each to be used to implement at least a portion of the machine-learned model during the activity. The set of interactive objects may include wearable devices worn by a group of users performing a sporting activity for example. The model distribution manager can determine a resource state associated with each of the wearable devices. Based on resource attributes associated with each of the wearable devices, for example, the model distribution manager can determine respective portions of the machine-learned model for execution by each of the wearable devices. The model distribution manager can generate configuration data for each wearable device that is indicative or otherwise associated with the respective portion of the machine-learned model for such interactive object. The model distribution manager can communicate the configuration data to each wearable device. In response to the configuration data, each wearable device can configure at least a portion of the machine-learned model identified by the configuration data. In some examples, the configuration data can identify a particular portion of the machine-learned model to be executed by the interactive object. The configuration data can include one or more portions of the machine-learned model to be executed by the interactive object in some instances. It is noted that in other instances, the interactive object may already store a portion or all of the machine-learned model and/or may retrieve or otherwise obtain all or a portion of the machine-learned model. The configuration data can additionally or alternatively include weights for one or more layers of the machine-learned model, one or more feature projections for one or more layers of the machine-learned model, scheduling data for execution of one or more portions of the machine-learned model, an identification of inputs for the machine-learned model (e.g., local sensor data inputs and/or intermediate future representations to be received from other interactive objects), and identification of outputs for the machine-learned model (e.g., computing devices to which inferences and/or intermediate representations are to be sent). Configuration data can include additional or alternative information in example embodiments.

An interactive object can configure one or more portions of a machine-learned model for local execution based on the configuration data. For example, the interactive object can configure one or more layers of the machine-learned model for local execution based on the configuration data. In some examples, the interactive object can configure the machine-learned model for processing using a particular set of model parameters based on the configuration data. For instance, the set of parameters can include weights, function mappings, etc. that the interactive object uses for the machine-learned model locally during processing. The parameters can be modified in response to updated configuration data.

During the activity, each interactive object can execute one or more portions of the machine-learned model identified by its respective configuration data. For example, a particular interactive object may receive sensor data generated by one or more local sensors on the interactive object. Additionally or alternatively, the interactive object may receive intermediate feature representations that may be generated by other portions of the machine-learned model at other interactive objects. The sensor data and/or other intermediate representations can be provided as input to one or more respective portions of the machine-learned model identified by the configuration data at the interactive object. The interactive object can obtain one or more outputs from the respective portion of the machine-learned model and provide data associated with the outputs in accordance with the configuration data. For example, the interactive object may transmit an intermediate representation or an inference to another interactive object of the set. It is noted that other computing devices such as tablets, smart phones, desktop computing devices ,cloud computing devices etc. may interact to execute portions of a machine-learned model in combination with the set of interactive objects. Accordingly, the interactive object may transmit inferences or intermediate representations to other types of computing devices in addition to other interactive objects.

During the activity, the model distribution manager can monitor the resource state of each interactive object. In response to changes to the resource states of interactive objects, the model distribution manager can reallocate one or more portions of the machine-learned model. For example, the model distribution manager can determine that a change in resource state associated with one or more interactive objects satisfies one or more threshold criteria. If the one or more threshold criteria are satisfied, the model distribution manager can determine that one or more portions of the machine-learned model should be reallocated for execution. The model distribution manager can determine the updated resource attributes associated with one or more interactive objects of the set. In response, the model distribution manager can determine respective portions of the machine-learned model for execution by the interactive objects based on the updated resource allocations. Updated configuration data can then be generated and transmitted to the appropriate interactive objects.

According to example aspects of the present disclosure, a model distribution manager can be implemented by one or more interactive objects of a set of interactive objects and/or one or more computing devices remote from the set of interactive objects. By way of example, a model distribution manager can be implemented on a user computing device such as a smart phone, tablet computing device, desktop computing device, etc. that is in communication with the set of wearable devices. As another example, the model distribution manager can be implemented on one or more cloud computing devices accessible to the set of wearable devices over one or more networks. In some embodiments, the model distribution manager can be implemented at or otherwise distributed over multiple computing devices.

In accordance with example embodiments, a set of interactive objects can be configured to communicate over one or more mesh networks during an activity. By utilizing a mesh network, the individual interactive objects can communicate with one another without necessarily passing through an intermediate computing device or other computing node. In this manner, sensor data and intermediate representations can be transmitted directly from one interactive object to another interactive object. Moreover, the utilization of a mesh network permits easy reconfiguration of a processing flow between individual interactive objects of the set. For example, a first interactive object may be configured to receive data from a second interactive object, process the data from the second interactive object, and transmit the result of the processing to a third interactive object. At a later time, the first interactive object can be reconfigured to receive data from a fourth interactive object, process the data from the fourth interactive object, and transmit the result of such processing to a fifth interactive object. Although mesh networks are principally described, any type of network can be used, such as networks including one or more of many types of wireless or partly wireless communication networks, such as a local-area-network (LAN), a wireless local-area-network (WLAN), a personal-area-network (PAN), a wide-area-network (WAN), an intranet, the Internet, a peer-to-peer network, point-to-point network, a mesh network, and so forth.

In accordance with example embodiments, a model distribution manager can allocate execution of machine-learned models such as neural networks, non-linear models, and/or linear models, for example, that are distributed across a plurality of computing devices to detect user movements based on sensor data generated at an interactive object. A machine-learned model may include one or more neural networks or other type of machine-learned models, including non-linear models and/or linear models. Neural networks can include feed-forward neural networks, recurrent neural networks (e.g., long short-term memory recurrent neural networks), convolutional neural networks or other forms of neural networks. More particularly, a machine-learned model such as a machine-learned classification model can include a plurality of layers such as a plurality of layers of one or more neural networks. The entire machine-learned model can be stored by each of a plurality of interactive objects in accordance with some example embodiments. In response to configuration data, individual interactive objects can be configured to execute individual portions such as a subset of layers of the neural network stored locally by the interactive object. In other examples, an interactive object can obtain one or more portions of the machine-learned model in response to the configuration data such that the entire machine-learned model is not necessarily stored at the interactive object. The individual portions of the machine-learned model can be included as part of the configuration data, or the interactive object can retrieve the portions of the machine-learned model identified by the configuration data. For instance, the interactive object can obtain and execute a subset of layers of a machine-learned model in response to configuration data.

An interactive object in accordance with example embodiments of the present disclosure can obtain configuration data associated with at least a portion of machine-learned model. The configuration data can identify or otherwise be associated with one or more portions of the machine-learned model that are to be executed locally by the interactive object. The configuration data can additionally or alternatively identify other interactive objects of a set of interactive objects, such as interactive object that is to provide data for one or more inputs of the machine-learned model at the particular interactive object, and/or other interactive objects to which the interactive object is transmit a result of its local processing. The interactive object can identify one or more portions of the machine-learned model to be executed locally in response to the configuration data. The interactive object can determine whether it currently stores or otherwise has local access to the identified portions of the machine-learned model. If the interactive object currently has local access to the identified portions of the machine-learned model, the interactive object can determine whether the local configuration of those portions should be modified in accordance with the configuration data. For instance, the interactive object can determine whether one or more weights should be modified in accordance with configuration data, whether one or more inputs to the model should be modified, or whether one or more outputs of the model should be modified. If the interactive object determines that the local configuration should be modified, the machine-learned model can be modified in accordance with configuration data. The modifications can include replacing weights for one or more layers of the machine-learned model, modifying one or more inputs or outputs, modifying one or more function mappings, or other modifications to the machine-learned model configuration at the interactive object. After making any modifications in accordance with the configuration data, the interactive object can deploy or redeploy the portions of the machine-learned model at the interactive object for use in combination with the set of interactive objects.

According to some example aspects, an interactive object can dynamically adjust or otherwise modify local machine-learned processing in accordance with configuration data received from the model distribution manager. For instance, a first interactive object can be configured to obtain sensor data from one or more local sensors and/or one or more intermediate feature representations that can be provided as input to a first portion of a machine-learned model configured at the first interactive object. The first interactive object can identify from the configuration data that the sensor data is to be received locally and that the one or more intermediate feature representations are to be received from a second interactive object, for example. The first interactive object can input the sensor data and intermediate feature representations into the machine-learned model at the interactive object. The first interactive object can receive as output from the machine-learned model one or more inferences and/or one or more intermediate feature representations. The first interactive object can identify from the configuration data that the output of the machine-learned model is to be transmitted to a third interactive object, for example. The first interactive object can later receive updated configuration data from the model distribution manager. In response to the updated configuration data, the first interactive object can be reconfigured to obtain one or more intermediate feature representations from a fourth interactive object to be used as input to the local layers of the machine-learned model at the first interactive object. The first interactive object can identify from the configuration data that the output of the machine-learned model is to be transmitted to a fifth interactive object, for example. It is noted that the configuration data may identify other types of computing devices from which data may be received by the interactive object or to which one or more outputs of the machine-learned processing are to be transmitted.

As a specific example, an interactive object in accordance with example embodiments can include a capacitive touch sensor comprising one or more sensing elements such as conductive threads. A touch input to the capacitive touch sensor can be detected by the one or more sensing elements using sensing circuitry connected to the one or more sensing elements. The sensing circuitry can generate sensor data based on the touch input. The sensor data can be analyzed by a machine-learned model as described herein to detect user movements or perform other classifications based on the touch input or other motion input. For instance, the sensor data can be provided to the machine-learned model implemented by one or more computing devices of a wearable sensing platform (e.g., including an interactive object).

As another example, an interactive object can include an inertial measurement unit configured to generate sensor data indicative of acceleration, velocity, and other movements. The sensor data can be analyzed by a machine-learned model as described herein to detect or recognize movements such as running, walking, sitting, jumping or other movements. Complex user and/or object movements can be identified using sensor data from multiple sensors and/or interactive objects. In some examples, a removable electronics module can be implemented within a shoe or other garment, garment accessory, or garment container. The sensor data can be provided to the machine-learned model implemented by a computing device of the removable electronics module at the interactive object. The machine-learned model can generate data associated with one or more movements detected by an interactive obj ect.

In some examples, a movement manager can be implemented at one or more of the computing devices at which the machine-learned model is provisioned. The movement manager may include one or more portions of a machine-learned model in some examples. In some examples, the movement manager may include portions of the machine-learned model at multiple ones of the computing devices at which the machine-learned model is provisioned. The movement manager can be configured to initiate one or more actions in response to detecting a user movement. For example, the movement manager can be configured to provide data indicative of the user movement to other applications at a computing device. By way of example, a detected user movement can be utilized within a health monitoring application or a game implemented at a local or remote computing device. A detected gesture can be utilized by any number of applications to perform a function within the application.

Systems and methods in accordance with the disclosed technology provide a number of technical effects and benefits, particularly in the areas of computing technology and distributed machine-learned processing of sensor data across multiple interactive objects. As one example, the systems and methods described herein can enable a computing system including a set of interactive objects to dynamically distribute execution of machine-learned processing within the computing system based on resource availability associated with individual computing nodes. The computing system can determine resource availability associated with a set of interactive objects and in response generate individual configuration data for the interactive object for processing using a machine-learned model. By dynamically allocating execution based on resource availability, improvements in computational resource usage can be achieved to enable complex motion detection that may not otherwise be possible by a set of interactive objects with limited computing capacity. For example, the computing system can detect an underutilized interactive object such as may be associated with a user exhibiting less motion than other users. In response, additional machine-learned processing can be allocated to such interactive object to increase the potential processing capabilities while avoiding the overconsumption of power by individual devices. Additionally, according to some example aspects, an interactive object may obtain portions of the machine-learned model based on configuration data received from a model distribution manager. In other examples, the interactive object may implement individual portions of a machine-learned model already stored by the interactive object. Such techniques can enable the interactive object to optimally utilize resources such as memory available on the interactive object.

By dynamically allocating and reallocating machine-learned processing amongst the set of interactive objects, a computing system can optimally process sensor data from multiple objects to generate inferences associated with combinations of the sensor data. Such systems and methods can permit minimal computational resources to be utilized, which can result in faster and more efficient execution relative to systems that statically generate inferences at a predetermined location. For example, in some implementations, the systems and methods described herein can be quickly and efficiently performed by a computing system including multiple computing devices at which a machine-learned model is distributed. Because the machine-learned model can dynamically be re-distributed amongst the set of interactive objects, the inference generation process can be performed more quickly and efficiently due to the reduced computational demands.

As such, aspects of the present disclosure can improve gesture detection, movement recognition, and other machine-learned processes that are performed using sensor data collected at relatively lightweight computing devices, such as those included within interactive objects. In this manner, the systems and methods described here can provide a more efficient operation of a machine-learned model across multiple computing devices in order to perform classifications and other processes efficiently. For instance, processing can be allocated to optimize for the minimal computing resources available at an interactive object at a particular time, then be allocated to optimize for additional computing resources as they may become available. By optimizing processing allocation, bandwidth usage and other computational resources can be minimized.

In some implementations, in order to obtain the benefits of the techniques described herein, the user may be required to allow the collection and analysis of location information associated with the user or their device. For example, in some implementations, users may be provided with an opportunity to control whether programs or features collect such information. If the user does not allow collection and use of such signals, then the user may not receive the benefits of the techniques described herein. The user can also be provided with tools to revoke or modify consent. In addition, certain information or data can be treated in one or more ways before it is stored or used, so that personally identifiable information is removed. As an example, a computing system can obtain real-time location data which can indicate a location, without identifying any particular user(s) or particular user computing device(s).

With reference now to the figures, example aspects of the present disclosure will be discussed in greater detail.

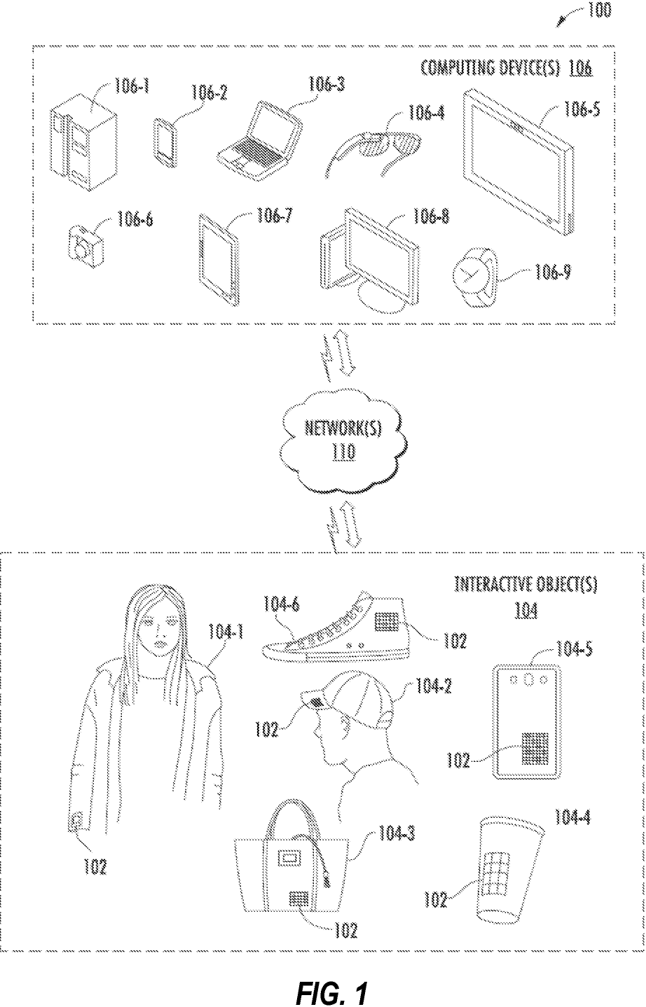

FIG. 1 is an illustration of an example environment 100 in which an interactive object including a touch sensor can be implemented. Environment 100 includes a touch sensor 102 (e.g., capacitive or resistive touch sensor), or other sensor. Touch sensor 102 is shown as being integrated within various interactive objects 104. Touch sensor 102 may include one or more sensing elements such as conductive threads or other sensing lines that are configured to detect a touch input. In some examples, a capacitive touch sensor can be formed from an interactive textile which is a textile that is configured to sense multi-touch-input. As described herein, a textile corresponds to any type of flexible woven material consisting of a network of natural or artificial fibers, often referred to as thread or yarn. Textiles may be formed by weaving, knitting, crocheting, knotting, pressing threads together or consolidating fibers or filaments together in a nonwoven manner. A capacitive touch sensor can be formed from any suitable conductive material and in other manners, such as by using flexible conductive lines including metal lines, filaments, etc. attached to a non-woven substrate.

In environment 100, interactive objects 104 include “flexible” objects, such as a shirt 104-1, a hat 104-2, a handbag 104-3 and a shoe 104-6. It is to be noted, however, that touch sensor 102 may be integrated within any type of flexible object made from fabric or a similar flexible material, such as garments or articles of clothing, garment accessories, garment containers, blankets, shower curtains, towels, sheets, bed spreads, or fabric casings of furniture, to name just a few. Examples of garment accessories may include sweat-wicking elastic bands to be worn around the head, wrist, or bicep. Other examples of garment accessories may be found in various wrist, arm, shoulder, knee, leg, and hip braces or compression sleeves. Headwear is another example of a garment accessory, e.g. sun visors, caps, and thermal balaclavas. Examples of garment containers may include waist or hip pouches, backpacks, handbags, satchels, hanging garment bags, and totes. Garment containers may be worn or carried by a user, as in the case of a backpack, or may hold their own weight, as in rolling luggage. Touch sensor 102 may be integrated within flexible objects 104 in a variety of different ways, including weaving, sewing, gluing, and so forth. Flexible objects may also be referred to as “soft” objects.

In this example, objects 104 further include “hard” objects, such as a plastic cup 104-4 and a hard smart phone casing 104-5. It is to be noted, however, that hard objects 104 may include any type of “hard” or “rigid” object made from non-flexible or semi-flexible materials, such as plastic, metal, aluminum, and so on. For example, hard objects 104 may also include plastic chairs, water bottles, plastic balls, or car parts, to name just a few. In another example, hard objects 104 may also include garment accessories such as chest plates, helmets, goggles, shin guards, and elbow guards. Alternatively, the hard or semi-flexible garment accessory may be embodied by a shoe, cleat, boot, or sandal. Touch sensor 102 may be integrated within hard objects 104 using a variety of different manufacturing processes. In one or more implementations, injection molding is used to integrate touch sensors into hard objects 104.

Touch sensor 102 enables a user to control an object 104 with which the touch sensor 102 is integrated, or to control a variety of other computing devices 106 via a network 108. Computing devices 106 are illustrated with various non-limiting example devices: server 106-1, smart phone 106-2, laptop 106-3, computing spectacles 106-4, television 106-5, camera 106-6, tablet 106-7, desktop 106-8, and smart watch 106-9, though other devices may also be used, such as home automation and control systems, sound or entertainment systems, home appliances, security systems, netbooks, and e-readers. Note that computing device 106 can be wearable (e.g., computing spectacles and smart watches), non-wearable but mobile (e.g., laptops and tablets), or relatively immobile (e.g., desktops and servers). Computing device 106 may be a local computing device, such as a computing device that can be accessed over a Bluetooth connection, near-field communication connection, or other local-network connection. Computing device 106 may be a remote computing device, such as a computing device of a cloud computing system.

Network 108 includes one or more of many types of wireless or partly wireless communication networks, such as a local-area-network (LAN), a wireless local-area-network (WLAN), a personal-area-network (PAN), a wide-area-network (WAN), an intranet, the Internet, a peer-to-peer network, point-to-point network, a mesh network, and so forth.

Touch sensor 102 can interact with computing devices 106 by transmitting touch data or other sensor data through network 108. Additionally or alternatively, touch sensor 102 may transmit gesture data, movement data, or other data derived from sensor data generated by the touch sensor 102. Computing device 106 can use the touch data to control computing device 106 or applications at computing device 106. As an example, consider that touch sensor 102 integrated at shirt 104-1 may be configured to control the user’s smart phone 106-2 in the user’s pocket, television 106-5 in the user’s home, smart watch 106-9 on the user’s wrist, or various other appliances in the user’s house, such as thermostats, lights, music, and so forth. For example, the user may be able to swipe up or down on touch sensor 102 integrated within the user’s shirt 104-1 to cause the volume on television 106-5 to go up or down, to cause the temperature controlled by a thermostat in the user’s house to increase or decrease, or to turn on and off lights in the user’s house. Note that any type of touch, tap, swipe, hold, or stroke gesture may be recognized by touch sensor 102.

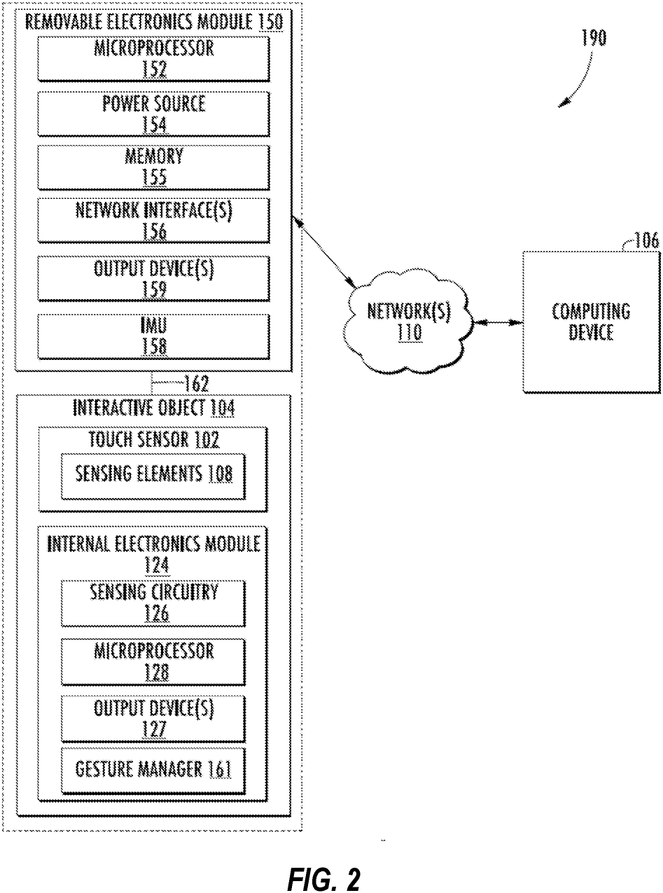

In more detail, consider FIG. 2 which illustrates an example environment 190 that includes an interactive object 104, a removable electronics module 150, and a computing device 106. In environment 190, touch sensor 102 is integrated in an object 104, which may be implemented as a flexible object (e.g., shirt 104-1, hat 104-2, or handbag 104-3) or a hard object (e.g., plastic cup 104-4 or smart phone casing 104-5).

Touch sensor 102 is configured to sense touch-input from a user when one or more fingers of the user’s hand touch or approach touch sensor 102. Touch sensor 102 may be configured as a capacitive touch sensor or resistive touch sensor to sense single-touch, multi-touch, and/or full-hand touch-input from a user. To enable the detection of touch-input, touch sensor 102 includes sensing elements 110. Sensing elements may include various shapes and geometries. In some examples, sensing elements 110 can be formed as a grid, array, or parallel pattern of sensing lines so as to detect touch input. In some implementations, the sensing elements 110 do not alter the flexibility of touch sensor 102, which enables touch sensor 102 to be easily integrated within interactive objects 104.

Interactive object 104 includes an internal electronics module 124 (also referred to as internal electronics device) that is embedded within interactive object 104 and is directly coupled to sensing elements 110. Internal electronics module 124 can be communicatively coupled to a removable electronics module 150 (also referred to as a removable electronics device) via a communication interface 162. Internal electronics module 124 contains a first subset of electronic circuits or components for the interactive object 104, and removable electronics module 150 contains a second, different, subset of electronic circuits or components for the interactive object 104. As described herein, the internal electronics module 124 may be physically and permanently embedded within interactive object 104, whereas the removable electronics module 150 may be removably coupled to interactive object 104.

In environment 190, the electronic components contained within the internal electronics module 124 include sensing circuitry 126 that is coupled to sensing elements 110 that form the touch sensor 102. In some examples, the internal electronics module includes a flexible printed circuit board (PCB). The printed circuit board can include a set of contact pads for attaching to the conductive lines. In some examples, the printed circuit board includes a microprocessor. For example, wires from conductive threads may be connected to sensing circuitry 126 using flexible PCB, creping, gluing with conductive glue, soldering, and so forth. In one embodiment, the sensing circuitry 126 can be configured to detect a user-inputted touch-input on the conductive threads that is pre-programmed to indicate a certain request. In one embodiment, when the conductive threads form a grid or other pattern, sensing circuitry 126 can be configured to also detect the location of the touch-input on sensing element 110, as well as motion of the touch-input. For example, when an object, such as a user’s finger, touches sensing element 110, the position of the touch can be determined by sensing circuitry 126 by detecting a change in capacitance on the grid or array of sensing element 110. The touch-input may then be used to generate touch data usable to control a computing device 106. For example, the touch-input can be used to determine various gestures, such as single-finger touches (e.g., touches, taps, and holds), multi-finger touches (e.g., two-finger touches, two-finger taps, two-finger holds, and pinches), single-finger and multi-finger swipes (e.g., swipe up, swipe down, swipe left, swipe right), and full-hand interactions (e.g., touching the textile with a user’s entire hand, covering textile with the user’s entire hand, pressing the textile with the user’s entire hand, palm touches, and rolling, twisting, or rotating the user’s hand while touching the textile).

Internal electronics module 124 can include various types of electronics, such as sensing circuitry 126, sensors (e.g., capacitive touch sensors woven into the garment, microphones, or accelerometers), output devices (e.g., LEDs, speakers, or micro-displays), electrical circuitry, and so forth. Removable electronics module 150 can include various electronics that are configured to connect and/or interface with the electronics of internal electronics module 124. Generally, the electronics contained within removable electronics module 150 are different than those contained within internal electronics module 124, and may include electronics such as microprocessor 152, power source 154 (e.g., a battery), memory 155, network interface 156 (e.g., Bluetooth, WiFi, USB), sensors (e.g., accelerometers, heart rate monitors, pedometers, IMUs), output devices (e.g., speakers, LEDs), and so forth.

In some examples, removable electronics module 150 is implemented as a strap or tag that contains the various electronics. The strap or tag, for example, can be formed from a material such as rubber, nylon, plastic, metal, or any other type of fabric. Notably, however, removable electronics module 150 may take any type of form. For example, rather than being a strap, removable electronics module 150 could resemble a circular or square piece of material (e.g., rubber or nylon).

The inertial measurement unit(s) (IMU(s)) 158 can generate sensor data indicative of a position, velocity, and/or an acceleration of the interactive object. The IMU(s) 158 may generate one or more outputs describing one or more three-dimensional motions of the interactive object 104. The IMU(s) may be secured to the internal electronics module 124, for example, with zero degrees of freedom, either removably or irremovably, such that the inertial measurement unit translates and is reoriented as the interactive object 104 is translated and are reoriented. In some embodiments, the inertial measurement unit(s) 158 may include a gyroscope or an accelerometer (e.g., a combination of a gyroscope and an accelerometer), such as a three axis gyroscope or accelerometer configured to sense rotation and acceleration along and about three, generally orthogonal axes. In some embodiments, the inertial measurement unit(s) may include a sensor configured to detect changes in velocity or changes in rotational velocity of the interactive object and an integrator configured to integrate signals from the sensor such that a net movement may be calculated, for instance by a processor of the inertial measurement unit, based on an integrated movement about or along each of a plurality of axes.

Communication interface 162 enables the transfer of power and data (e.g., the touch-input detected by sensing circuitry 126) between the internal electronics module 124 and the removable electronics module 260. In some implementations, communication interface 162 may be implemented as a connector that includes a connector plug and a connector receptacle. The connector plug may be implemented at the removable electronics module 150 and is configured to connect to the connector receptacle, which may be implemented at the interactive object 104. One or more communication interface(s) may be included in some examples. For instance, a first communication interface may physically couple the removable electronics module 150 to one or more computing devices 106, and a second communication interface may physically couple the removable electronics module 150 to interactive object 104.

In environment 190, the removable electronics module 150 includes a microprocessor 152, power source 154, and network interface 156. Power source 154 may be coupled, via communication interface 162, to sensing circuitry 126 to provide power to sensing circuitry 126 to enable the detection of touch-input, and may be implemented as a small battery. When touch-input is detected by sensing circuitry 126 of the internal electronics module 124, data representative of the touch-input may be communicated, via communication interface 162, to microprocessor 152 of the removable electronics module 150. Microprocessor 152 may then analyze the touch-input data to generate one or more control signals, which may then be communicated to a computing device 106 (e.g., a smart phone, server, cloud computing infrastructure, etc.) via the network interface 156 to cause the computing device to initiate a particular functionality. Generally, network interfaces 156 are configured to communicate data, such as touch data, over wired, wireless, or optical networks to computing devices. By way of example and not limitation, network interfaces 156 may communicate data over a local-area-network (LAN), a wireless local-area-network (WLAN), a personal-area-network (PAN) (e.g., Bluetooth™), a wide-area-network (WAN), an intranet, the Internet, a peer-to-peer network, point-to-point network, a mesh network, and the like (e.g., through network 108 of FIG. 1 and FIG. 2).

Object 104 may also include one or more output devices 127 configured to provide a haptic response, a tactical response, an audio response, a visual response, or some combination thereof. Similarly, removable electronics module 150 may include one or more output devices 159 configured to provide a haptic response, tactical response, and audio response, a visual response, or some combination thereof. Output devices may include visual output devices, such as one or more light-emitting diodes (LEDs), audio output devices such as one or more speakers, one or more tactile output devices, and/or one or more haptic output devices. In some examples, the one or more output devices are formed as part of removable electronics module, although this is not required. In one example, an output device can include one or more LEDs configured to provide different types of output signals. For example, the one or more LEDs can be configured to generate a circular pattern of light, such as by controlling the order and/or timing of individual LED activations. Other lights and techniques may be used to generate visual patterns including circular patterns. In some examples, one or more LEDs may produce different colored light to provide different types of visual indications. Output devices may include a haptic or tactile output device that provides different types of output signals in the form of different vibrations and/or vibration patterns. In yet another example, output devices may include a haptic output device such as may tighten or loosen an interactive garment with respect to a user. For example, a clamp, clasp, cuff, pleat, pleat actuator, band (e.g., contraction band), or other device may be used to adjust the fit of a garment on a user (e.g., tighten and/or loosen). In some examples, an interactive textile may be configured to tighten a garment such as by actuating conductive threads within the touch sensor 102.

A gesture manager 161 is capable of interacting with applications at computing devices 106 and touch sensor 102 effective to aid, in some cases, control of applications through touch-input received by touch sensor 102. For example, gesture manager 161 can interact with applications. In FIG. 2, gesture manager 161 is illustrated as implemented at internal electronics module 124. It will be appreciated, however, that gesture manager 161 may be implemented at removable electronics module 150, a computing device 106 remote from the interactive object, or some combination thereof. A gesture manager may be implemented as a standalone application in some embodiments. In other embodiments, a gesture manager may be incorporated with one or more applications at a computing device.

A gesture or other predetermined motion can be determined based on touch data detected by the touch sensor 102 and/or an inertial measurement unit 158 or other sensor. For example, gesture manager 161 can determine a gesture based on touch data, such as single-finger touch gesture, a double-tap gesture, a two-finger touch gesture, a swipe gesture, and so forth. As another example, gesture manager 161 can determine a gesture based on movement data such as a velocity, acceleration, etc. as can be determined by inertial measurement unit 158.

A functionality associated with a gesture can be determined by gesture manager 161 and/or an application at a computing device. In some examples, it is determined whether the touch data corresponds to a request to perform a particular functionality. For example, the motion manager determines whether touch data corresponds to a user input or gesture that is mapped to a particular functionality, such as initiating a vehicle service, triggering a text message or other notification, answering a phone call, creating a journal entry, and so forth. As described throughout, any type of user input or gesture may be used to trigger the functionality, such as swiping, tapping, or holding touch sensor 102. In one or more implementations, a motion manager enables application developers or users to configure the types of user input or gestures that can be used to trigger various different types of functionalities. For example, a gesture manager can cause a particular functionality to be performed, such as by sending a text message or other communication, answering a phone call, creating a journal entry, increase the volume on a television, turn on lights in the user’s house, open the automatic garage door of the user’s house, and so forth.

While internal electronics module 124 and removable electronics module 150 are illustrated and described as including specific electronic components, it is to be appreciated that these modules may be configured in a variety of different ways. For example, in some cases, electronic components described as being contained within internal electronics module 124 may be at least partially implemented at the removable electronics module 150, and vice versa. Furthermore, internal electronics module 124 and removable electronics module 150 may include electronic components other that those illustrated in FIG. 2, such as sensors, light sources (e.g., LED’s), displays, speakers, and so forth.

Although many example embodiments of the present disclosure are described with respect to movement detection using inertial measurement units or other sensors, it will be appreciated that the disclosed technology may be used with any type of sensor data to generate any type of inference based on the state or attributes of a user. For example, an interactive object may include sensors such as one or more sensors configured to detect various physiological responses of a user. For instance, a sensor system can include an electrodermal activity sensor (EDA), a photoplethysmogram (PPG) sensor, a skin temperature sensor, and/or an inertial measurement unit (IMU). Additionally or alternatively, a sensor system can include an electrocardiogram (ECG) sensor, an ambient temperature sensor (ATS), a humidity sensor, a sound sensor such as a microphone, an ambient light sensor (ALS), a barometric pressure sensor (e.g., barometer)

By way of example, sensing circuitry 126 can determine or generate sensor data associated with various sensors. In an example, sensing circuitry 126 can cause a current flow between EDA electrodes (e.g., an inner electrode and an outer electrode) through one or more layers of a user’s skin in order to measure an electrical characteristic associated with the user. For example, the sensing circuitry may utilize current sensing to determine an amount of current flow between the electrodes through the user’s skin. The amount of current may be indicative of electrodermal activity. The wearable device can provide an output based on the measured current in some examples. A photoplethysmogram (PPG) sensor can generate sensor data indicative of changes in blood volume in the microvascular tissue of a user. The PPG sensor may generate one or more outputs describing the changes in the blood volume in a user’s microvascular tissue. An ECG sensor can generate sensor data indicative of the electrical activity of the heart using electrodes in contact with the skin. The ECG sensor can include one or more electrodes in contact with the skin of a user. A skin temperature sensor can generate data indicative of the user’s skin temperature. The skin temperature sensor can include one or more thermocouples indicative of the temperature and changes in temperature of a user’s skin.

Interactive object 104 can include various other types of electronics, such as additional sensors (e.g., capacitive touch sensors, microphones, accelerometers, ambient temperature sensor, barometer, ECG, EDA, PPG), output devices (e.g., LEDs, speakers, or haptic devices), electrical circuitry, and so forth. The various electronics depicted within interactive object 104 may be physically and permanently embedded within interactive object 104 in example embodiments. In some examples, one or more components may be removably coupled to the interactive object 104. By way of example, a removable power source 154 may be included in example embodiments.

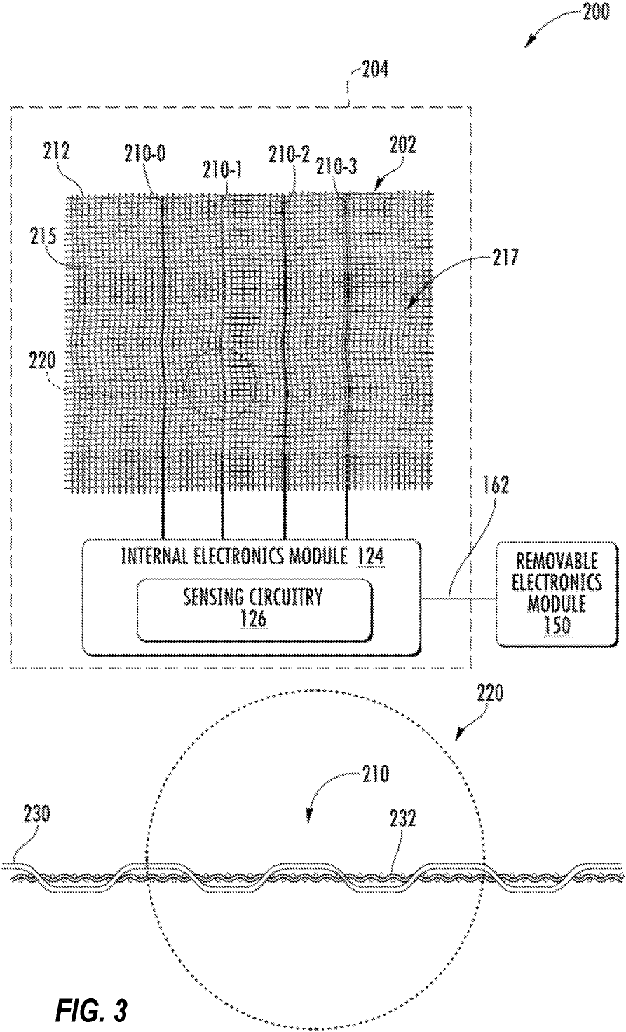

FIG. 3 illustrates an example of a sensor system 200, such as can be integrated with an interactive object 104 in accordance with one or more implementations. In this example, the sensing elements 110 are implemented as conductive threads 210 on or within a substrate 215. The touch sensor includes non-conductive threads 212 woven with conductive threads 210 to form a capacitive touch sensor (e.g., interactive textile). It is noted that a similar arrangement may be used to form a resistive touch sensor. Non-conductive threads 212 may correspond to any type of non-conductive thread, fiber, or fabric, such as cotton, wool, silk, nylon, polyester, and so forth.

At 220, a zoomed-in view of conductive thread 210 is illustrated. Conductive thread 210 includes a conductive wire 230 or a plurality of conductive filaments that are twisted, braided, or wrapped with a flexible thread 232. As shown, the conductive thread 210 can be woven with or otherwise integrated with the non-conductive threads 212 to form a fabric or a textile. Although a conductive thread and textile is illustrated, it will be appreciated that other types of sensing elements and substrates may be used, such as flexible metal lines formed on a plastic substrate.

In one or more implementations, conductive wire 230 is a thin copper wire. It is to be noted, however, that the conductive wire 230 may also be implemented using other materials, such as silver, gold, or other materials coated with a conductive polymer. The conductive wire 230 may include an outer cover layer formed by braiding together non-conductive threads. The flexible thread 232 may be implemented as any type of flexible thread or fiber, such as cotton, wool, silk, nylon, polyester, and so forth.

A capacitive touch sensor can be formed cost-effectively and efficiently, using any conventional weaving process (e.g., jacquard weaving or 3D-weaving), which involves interlacing a set of longer threads (called the warp) with a set of crossing threads (called the weft). Weaving may be implemented on a frame or machine known as a loom, of which there are a number of types. Thus, a loom can weave non-conductive threads 212 with conductive threads 210 to create a capacitive touch sensor. In another example, a capacitive touch sensor can be formed using a pre-defined arrangement of sensing lines formed from a conductive fabric such as an electro-magnetic fabric including one or more metal layers.

The conductive threads 210 can be formed into the touch sensor in any suitable pattern or array. In one embodiment, for instance, the conductive threads 210 may form a single series of parallel threads. For instance, in one embodiment, the capacitive touch sensor may comprise a single plurality of parallel conductive threads conveniently located on the interactive object, such as on the sleeve of a jacket.

In an alternative embodiment, the conductive threads 210 may form a grid that includes a first set of substantially parallel conductive threads and a second set of substantially parallel conductive threads that crosses the first set of conductive threads to form the grid. For instance, the first set of conductive threads can be oriented horizontally and the second set of conductive threads can be oriented vertically, such that the first set of conductive threads are positioned substantially orthogonal to the second set of conductive threads. It is to be appreciated, however, that conductive threads may be oriented such that crossing conductive threads are not orthogonal to each other. For example, in some cases crossing conductive threads may form a diamond-shaped grid. While conductive threads 210 are illustrated as being spaced out from each other in FIG. 3, it is to be noted that conductive threads 210 may be formed very closely together. For example, in some cases two or three conductive threads may be weaved closely together in each direction. Further, in some cases the conductive threads may be oriented as parallel sensing lines that do not cross or intersect with each other.

In example system 200, sensing circuitry 126 is shown as being integrated within object 104, and is directly connected to conductive threads 210. During operation, sensing circuitry 126 can determine positions of touch-input on the conductive threads 210 using self-capacitance sensing or projective capacitive sensing.

The conductive thread 210 and sensing circuitry 126 re configured to communicate the touch data that is representative of the detected touch-input to gesture manager 161 (e.g., at removable electronics module 150). The microprocessor 152 may then cause communication of the touch data, via network interface 156, to computing device 106 to enable the device to determine gestures based on the touch data, which can be used to control object 104, computing device 106, or applications implemented at computing device 106. In some implementations, a predefined motion may be determined by the internal electronics module and/or the removable electronics module and data indicative of the predefined motion can be communicated to a computing device 106 to control object 104, computing device 106, or applications implemented at computing device 106.

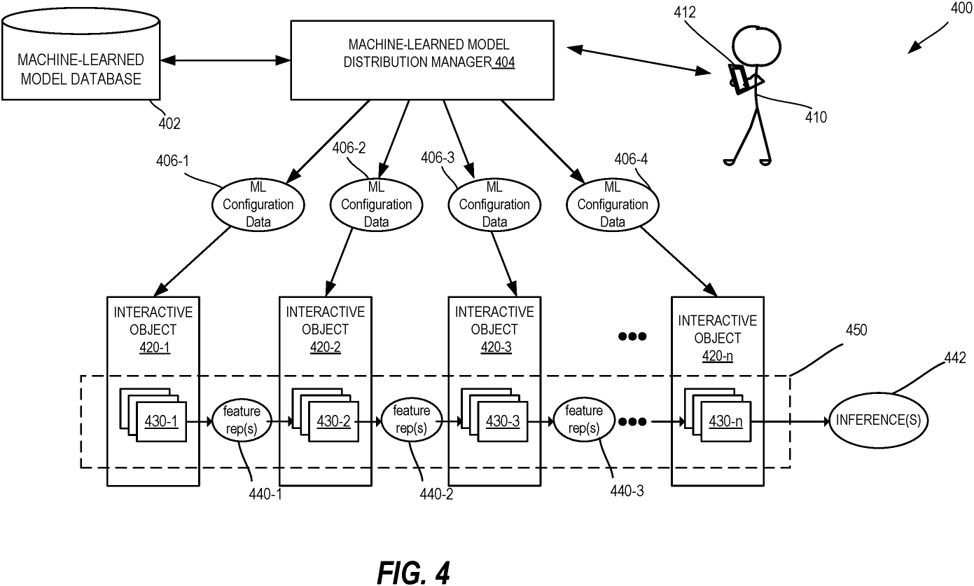

FIG. 4 depicts an example of a computing environment including a distributed machine-learned model under the control of a model distribution manager in accordance with example embodiments of the present disclosure. Computing environment 400 includes a plurality of interactive objects 420-1 to 420-n, a machine-learned model database 402, a machine-learned model distribution manager 404, and a remote computing device 412. In example embodiments, the interactive objects 420, machine-learned (ML) model distribution manager 404, and a computing device 412 can be in communication over one or more networks. The network(s) can include one or more of many types of wireless or partly wireless communication networks, such as a local-area-network (LAN), a wireless local-area-network (WLAN), a personal-area-network (PAN), a wide-area-network (WAN), an intranet, the Internet, a peer-to-peer network, point-to-point network, a mesh network, and so forth. In some examples, the computing components can be in communication over one or more mesh networks including bluetooth connections, near-field communication connections, or other local-network connections. In example embodiments, a mesh network can enable the interactive objects to communicate with each other and other computing devices such as computing device 412 directly. Combinations of different network types may be used. For example, a computing device 412 may be a remote computing device accessed in the cloud or otherwise over other network connections.

Machine-learned model distribution manager 404 can dynamically distribute machine-learned model 450 and its execution among the set of interactive objects. More particularly, ML model distribution manager 404 can dynamically distribute individual portions of machine-learned model 450 across the set of interactive objects. The distribution of the individual portions can be initially allocated and then reallocated based on conditions such as the state of individual interactive objects. In some examples, the dynamic allocation of the machine-learned model is based on resource attributes associated with the interactive objects.

ML model distribution manager 404 can identify a particular machine-learned model 450 from machine-learned model database 402 that is to be utilized by the set of interactive objects. In some examples, ML model distribution manager 404 can receive user input such as from user 410 utilizing computing device 412 to indicate a particular machine-learned model to be used. In other examples, user 410 may indicate an activity or other event to be performed utilizing the interactive objects and ML model distribution manager 404 can determine an appropriate machine-learned model in response. Machine-learned model distribution manager 404 can access an appropriate machine-learned model from machine-learned model database 402 and distribute the machine-learned model across the set of interactive objects 420. In some examples, interactive objects 420 may already store a machine-learned model such that the actual model does not have to be distributed from a database to the individual interactive objects. In other examples, however, a portion or all of the machine-learned model can be retrieved from the database and provided to each of the interactive objects. In yet another example, one or more portions of the machine-learned model can be obtained from another interactive object or computing device and provided to the appropriate interactive object in accordance with configuration data.

Machine-learned model distribution manager 404 can determine that the set of interactive objects 420 is to implement machine-learned model 450 in order to monitor an activity or some other occurrence utilizing multiple ones of the interactive objects. In response, ML model distribution manager 404 can dynamically distribute portions of the machine-learned model to individual interactive objects during the activity. In some examples, the computing system can obtain data indicative of resources available or predicted to be available to the individual interactive objects during the activity. Based on resource attribute data indicative of such resource availability, such as processing cycles, memory, power, bandwidth, etc., the ML model distribution manager 404 can assign execution of individual portions of the machine-learned model to certain wearable devices. The ML model distribution manager 404 can monitor the resources available to the interactive objects 420 during the activity. In response to detecting changes in resource availability or other resource state information, the ML model distribution manager 404 can dynamically redistribute execution of portions of the machine-learned model among the interactive objects. By dynamically allocating and re-allocating machine-learned processing among interactive objects based on their resource capabilities during an activity, ML model distribution manager 404 can adapt to resource variability of the interactive objects. For instance, a user may take a break from an activity which can result in increased availability of computational resources in response to the reduced movement by the user. In accordance with some aspects of the present disclosure, a computing system can respond by re-allocating additional machine-learned processing to such an interactive object.

A machine-learned model 450 is distributed across the plurality of interactive objects 420 in order to generate inferences based on combinations of sensor data from two or more of the interactive objects. Although not shown, the machine-learned model can be further distributed at computing device 412 which may be a smartphone, desktop computer, tablet, or other non-interactive object. It is noted that model 450 can be a single machine-learned model distributed across the set interactive objects such that different functions of the model are performed at different interactive objects. In this respect, the portions at teach interactive object are not individual instances or copies of the same model that perform the same function at each interactive object. Instead, model 450 has functions distributed across the different interactive objects such that the model generates inferences in association with combinations of sensor data at multiple ones of the interactive objects. In the specifically described example, each interactive object stores one or more layers of the same machine-learned model 450. For instance, interactive object 420-1 stores layers 430-1, interactive object 420-2 stores layers 430-2, interactive object 420-3 stores layers 430-3, and interactive object 420-n stores layers 430-n. The portions of the model at each interactive object generate feature representations and/or a final inference associated with the feature representations. Interactive object 420-1 generates one more feature representations 440-1 using layers 430-1 of the machine-learned model 450. Interactive object 420-2 generates one or more feature representations 440-2 using layers 430-2 of the machine-learned model 450. Interactive object 420-3 generates one or more feature representations 440-3 using layers 430-3. Interactive object 420-n generates one or more inferences 442 using layers 430-n of machine-learned model 450. In this manner, it can be seen that machine-learned model 450 generates an inference 442 based on a combination of sensor data from at least two of the interactive objects. For example, the feature representations generated by at least two of the interactive objects can be utilized to generate inference 442.

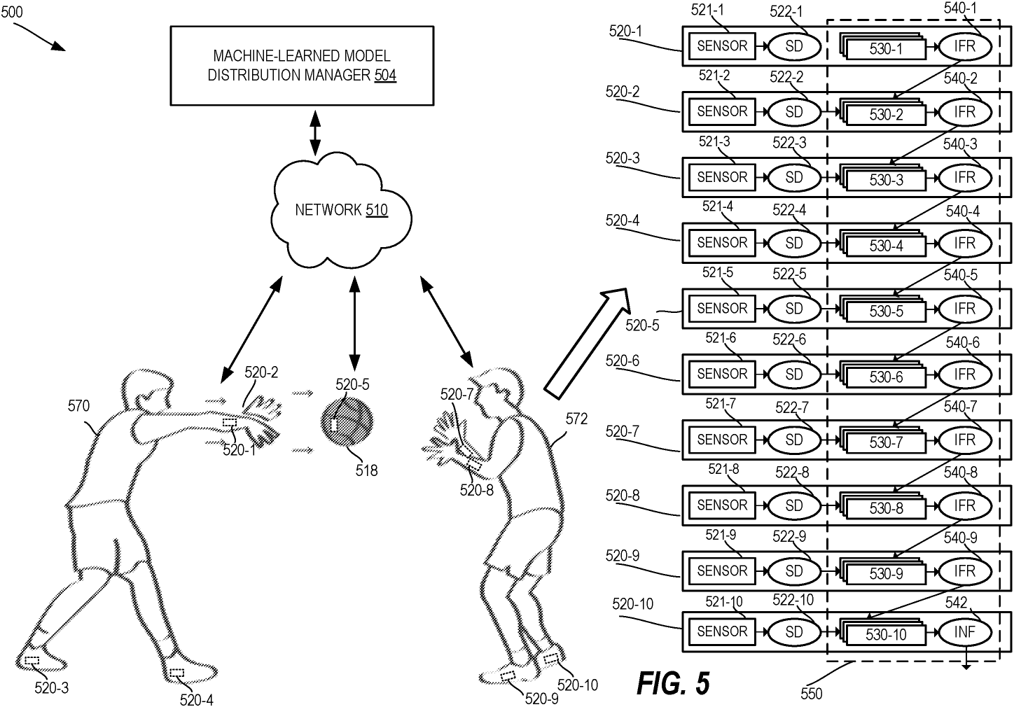

FIG. 5 depicts an example of a computing environment including a set of interactive objects 520-1 to 520-10 that execute a machine-learned model 550 in order to detect movements based on sensor data associated with users 570, 572 during an activity in accordance with example embodiments of the present disclosure. Although a specific example is illustrated with respect to detecting movement, will be appreciated that the disclosed technology is not so limited. For example, a set of interactive objects may be configured with a machine-learned model in order to generate inferences associated with temperature, user state, or any other suitable inference. Machine-learned model distribution manager 504 can communicate with the interactive objects over one or more networks 510 in order to manage the distribution of the machine-learned model across the interactive objects. Each interactive object 520 is configured with at least a respective portion of machine-learned model 550 that as a whole generates inferences 542 in association with user movements detected by the set of interactive objects during an activity such as a sporting event (e.g., soccer, basketball, football, etc.). User 570 wears or otherwise has disposed on their person interactive objects 520-1 (on their right arm), 520-2 (on their left arm), 520-3 (on their right foot), and 520-4 (on their left foot). User 572 wears or otherwise has disposed on their person interactive objects 520-7 (on their right arm), 520-8 (on their left arm), 520-9 (on their left foot), and 520-10 (on their right foot). Additionally, a ball 518 is equipped with an interactive object 520-5. In example embodiments, interactive objects 520-1, 520-2, 520-3, 520-4, 520-7, 520-8, 520-9, and 520-10 can be implemented as wearable devices that are equipped with one or more sensors and processing circuitry (e.g., microprocessor, application-specific integrated circuit, etc.). Interactive object 520-5 can be implemented as one or more electronic modules including one or more sensors and processing circuitry that are removably or irremovably coupled with ball 518. The one or more sensors of the various interactive objects can generate sensor data indicative of user movements and the processing circuitry can process the sensor data, alone or in combination with other processing circuitry and/or sensor data, to generate inferences associated with user movements. Multiple interactive objects 520 may be utilized in order to generate an inference 542 associated with the user movements. Machine-learned model 550 can be dynamically distributed and re-distributed amongst the multiple interactive objects to generate inferences based on the combined sensor data of the multiple objects.

Each interactive object 520 include one or more sensors that generate sensor data 522. The sensor data 522 can be provided as one or more inputs to one or more layers 530 of machine-learned model 550 at the individual interactive object. For example, interactive object 520-1 includes sensor 521-2 that generates sensor data 522-1 which is provided as an input to one or more layers 530-1 of machine-learned model 550. Layer(s) 530-1 generate one or more intermediate feature representations 540-1. Interactive object 520-2 includes one or more sensors which generate sensor data 522-2 which is provided as one or more inputs to layers 530-2 of machine-learned model 550. Layers 530-2 additionally receive as inputs the intermediate feature representations 540-1 from the first interactive object 520-1. Layers 530-2 then generate one or more intermediate feature representations 540-2 based on sensor data 522-2 as well as the intermediate feature representations 540-1. In the particularly described example of FIG. 5, this process continues through the sequence of interactive objects 520-3 to 520-10. Interactive object 520-10 generates one or more inferences 540-10 utilizing the sensor data from interactive object 520-10 as well as the intermediate feature representations 540-9 from interactive object 520-9.

In this manner, machine-learned model 550 can generate an inference 542 based on combinations of sensor data from multiple interactive objects. For instance, a machine-learned classifier may be used to detect a pass of ball 518 between user 570 and user 572 based on the sensor data generated by inertial measurement units of wearable devices worn by the players and/or sensor data generated by an inertial measurement unit disposed on ball 518. As another example, a classification model can be configured to classify a user movement including a basketball shot that includes both a jump motion and an arm motion. By way of example, an inference 542 generated by machine-learned model 550 may be based on a combination of sensor data associated with the nine inertial measurement units depicted in FIG. 5 or some subset thereof. Various types of neural networks such as convolutional neural networks, feed forward neural networks, and the like can be used to generate inferences based on combinations of sensor data from individual objects. In some examples, a residual network may be utilized to combine feature representations generated by one or more earlier layers of a machine-learned model with sensor data from a local interactive object. A machine-learned classifier can utilize the outputs of the sensors to determine whether a shot, pass, or other event has occurred.

Processing by the machine-learned classification model 550 can be dynamically distributed amongst the interactive objects and/or other computing devices based on parameters such as resource attributes associated with the individual interactive objects. For instance, ML model distribution manager 504 may determine that interactive objects 520-3 and 520-4 associated with user 570 are less utilized relative to the other interactive objects. ML model distribution manager 504 can determine that these interactive objects have greater resource capabilities (e.g., more power availability, more bandwidth, and/or more computational resources, etc.) than one or more other interactive objects at a particular time during the activity. In response, ML model distribution manager 504 can distribute execution of a larger portion of the machine-learned model to interactive objects 520-3 and 520-4. The distribution of machine-learned processing to the various interactive objects can include transmitting configuration data to the interactive objects. The configuration data can include data indicative of portions of the machine-learned model to be executed by the interactive object and/or identifying information of sources of data to be used for such processing. For instance, the configuration data may identify the location of other computing nodes (e.g., other wearable devices) to which intermediate feature representations and/or inferences should be transmitted or from which such data should be received. In other examples, the configuration data can include portions of the machine-learned model itself.

The interactive objects can configure one or more portions of the machine-learned model based on the configuration data. For example, an interactive object can determine layers of the model to be executed locally, the identification of other computing devices that will provide inputs, and the identification of other computing devices that are to receive outputs. In this manner, the internal propagation of feature representations within a machine-learned model can be modified based on the configuration data. Because machine-learned models are inherently causal systems such that data generally propagates in a defined direction, the reallocation of processing can be managed so that appropriate data flows remain. For instance, the input and output locations can be redefined as processing and the model is redistributed so that a particular interactive object receives feature representations from an appropriate interactive object and provides its generated feature representations to an appropriate interactive object.

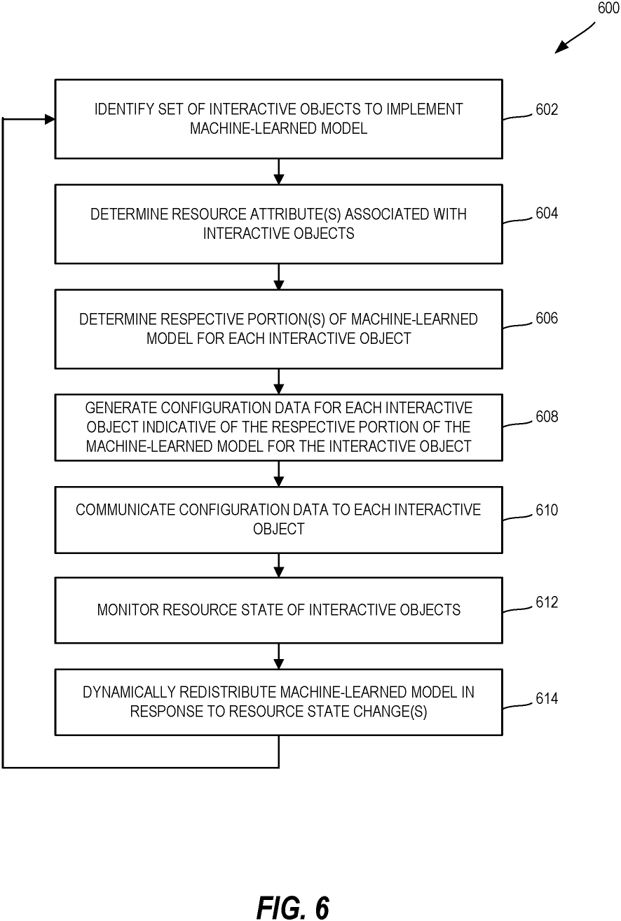

FIG. 6 illustrates an example method 600 of dynamically distributing a machine-learned model across a set of interactive objects in accordance with example embodiments of the present disclosure. Method 600 and other methods described herein (e.g., methods 900 and 950) are shown as sets of blocks that specify operations performed but are not necessarily limited to the order or combinations shown for performing the operations by the respective blocks. One or more portions of method 600, and the other methods described herein (method 900 and/or method 950), can be implemented by one or more computing devices such as, for example, one or more computing devices of a computing environments 100, 190, 400, 500, 700, or 1000, or computing devices 1110 or 1150. While in portions of the following discussion reference may be made to a particular computing environment, reference to which is made for example only. The techniques are not limited to performance by one entity or multiple entities operating on one device. One or more portions of these processes can be implemented as an algorithm on the hardware components of the devices described herein.

At 602, method 600 includes identifying a set of interactive objects to implement a machine-learned model. By way of example, an ML model distribution manager can determine that a set of interactive objects is to implement a machine-learned model in order to monitor an activity. In some examples, a user can provide an input via a graphical user interface, for example, to identify the set of interactive objects. In other examples, the ML model distribution manager can automatically detect the set of interactive objects, such as by detecting a set of interactive objects that are communicatively coupled to a mesh network. For instance, a plurality of users (e.g., players, coaches, referees etc.) can each wear or otherwise have disposed on their person an interactive object such as a wearable device that is equipped with one or more sensors and processing circuitry (e.g., microprocessor, application-specific integrated circuit, etc.). Additionally or alternatively, interactive objects not associated with an individual may be used. For instance, a piece of sporting equipment such as a ball, goal, portion of a field, etc. may include or otherwise form an interactive object by the incorporation of one or more sensors and processing circuitry.

At 604, method 600 includes determining a resource state associated with each of the interactive objects. Various interactive objects may have different resource capabilities that can be represented as resource attributes. The machine-learned model distribution manager can determine initial resource capabilities associated with an interactive object as well as real-time resource availability while the interactive object is in use. In various examples, the ML model distribution manager can request information regarding resource attributes associated with each interactive object. In some examples, general resource capability information may be stored such as in a database accessible to the model distribution manager. The ML model distribution manager can receive specific resource state information from each interactive object. The resource state information may be real-time information representing a current amount of computing resources available to the interactive object. In some examples, an ML model distribution manager can obtain data indicative of resources available or predicted to be available to the individual interactive objects during the activity. The resource availability data can indicate resource availability, such as processing cycles, memory, power, bandwidth, etc. The ML model distribution manager can receive data indicative of resources available to an interactive object prior to the commencement of an activity in some examples.

At 606, method 600 includes determining respective portions of the machine-learned model for execution by each of the interactive objects. Based on resource attribute data indicative of such resource availability, such as processing cycles, memory, power, bandwidth, etc., the computing system can assign execution of individual portions of the machine-learned model to certain wearable devices. For instance, if a first interactive object has greater resource capability (e.g., more power availability, more bandwidth, and/or more computational resources, etc.) than a second interactive object at a particular time during the activity, execution of a larger portion of the machine-learned model can be allocated to the first interactive object. If at a later time the second interactive object has greater resource capability, execution of a larger portion of the machine-learned model can be allocated to the second interactive object.

At 608, method 600 includes generating configuration data for each interactive object associated with the respective portion of the machine-learned model for the interactive object. The configuration data can identify or otherwise be associated with one or more portions of the machine-learned model that are to be executed locally by the interactive object. The configuration data can additionally or alternatively identify other interactive objects of a set of interactive objects, such as interactive object that is to provide data for one or more inputs of the machine-learned model at the particular interactive object, and/or other interactive objects to which the interactive object is transmit a result of its local processing. The configuration data can include data indicative of portions of the machine-learned model to be executed by the interactive object and/or identifying information of sources of data to be used for such processing. For instance, the configuration data may identify the location of other computing nodes (e.g., other wearable devices) to which intermediate feature representations and/or inferences should be transmitted or from which such data should be received. In other examples, the configuration data can include portions of the machine-learned model itself.

The configuration data can additionally or alternatively include weights for one or more layers of the machine-learned model, one or more feature projections for one or more layers of the machine-learned model, scheduling data for execution of one or more portions of the machine-learned model, an identification of inputs for the machine-learned model (e.g., local sensor data inputs and/or intermediate future representations to be received from other interactive objects), and identification of outputs for the machine-learned model (e.g., computing devices to which inferences and/or intermediate representations are to be sent). Configuration data can include additional or alternative information in example embodiments.

At 610, method 600 includes communicating the configuration data to each interactive object. An interactive object in accordance with example embodiments of the present disclosure can obtain configuration data associated with at least a portion of machine-learned model. The interactive object can identify one or more portions of the machine-learned model to be executed locally in response to the configuration data. The interactive object can determine whether it currently stores or otherwise has local access to the identified portions of the machine-learned model. If the interactive object currently has local access to the identified portions of the machine-learned model, the interactive object can determine whether the local configuration of those portions should be modified in accordance with the configuration data. For instance, the interactive object can determine whether one or more weights should be modified in accordance with configuration data, whether one or more inputs to the model should be modified, or whether one or more outputs of the output should be modified. If the interactive object determines that the local configuration should be modified, the machine-learned model can be modified in accordance with configuration data. The modifications can include replacing weights for one or more layers of the machine-learned model, modifying one or more inputs or outputs, modifying one or more function mappings, or other modifications to the machine-learned model configuration at the interactive object. After making any modifications in accordance with the configuration data, the interactive object can deploy or redeploy the portions of the machine-learned model at the interactive object for use in combination with the set of interactive objects.

At 612, method 600 includes monitoring the resource state associated with each interactive object. The ML model distribution manager can monitor the resources available to the interactive objects during the activity. The ML model distribution manager can monitor the interactive object and determine resource attribute data indicative of resource availability, such as processing cycles, memory, power, bandwidth, etc., as activity is ongoing. Changes to the distribution of the machine-learned model can be identified so that the computing system can assign execution of individual portions of the machine-learned model to certain interactive objects.

At 614, method 600 includes dynamically redistributing execution of the machine-learned model across the set of interactive objects in response to resource state changes. In response to changes to the resource states of interactive objects, the model distribution manager can reallocate one or more portions of the machine-learned model. For example, the model distribution manager can determine that a change in resource state associated with one or more interactive objects satisfies one or more threshold criteria. If the one or more threshold criteria are satisfied, the model distribution manager can determine that one or more portions of the machine-learned model should be reallocated for execution. The model distribution manager can determine the updated resource attributes associated with one or more wearable devices of the set. In response, the model distribution manager can determine respective portions of the machine-learned model for execution by the wearable devices based on the updated resource allocations. Updated configuration data can then be generated and transmitted to the appropriate interactive objects.

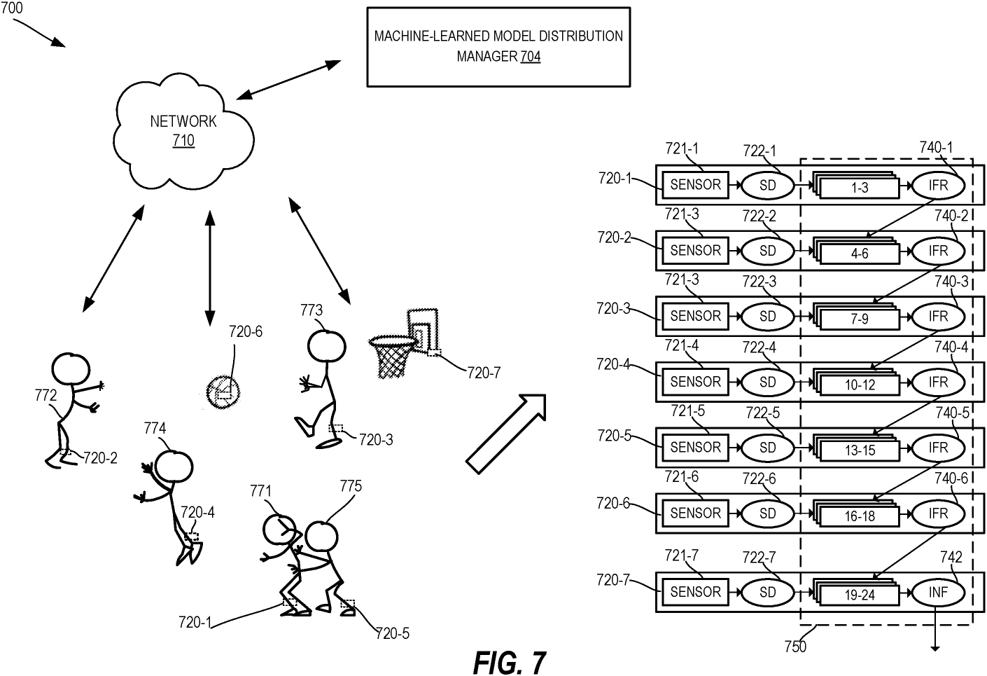

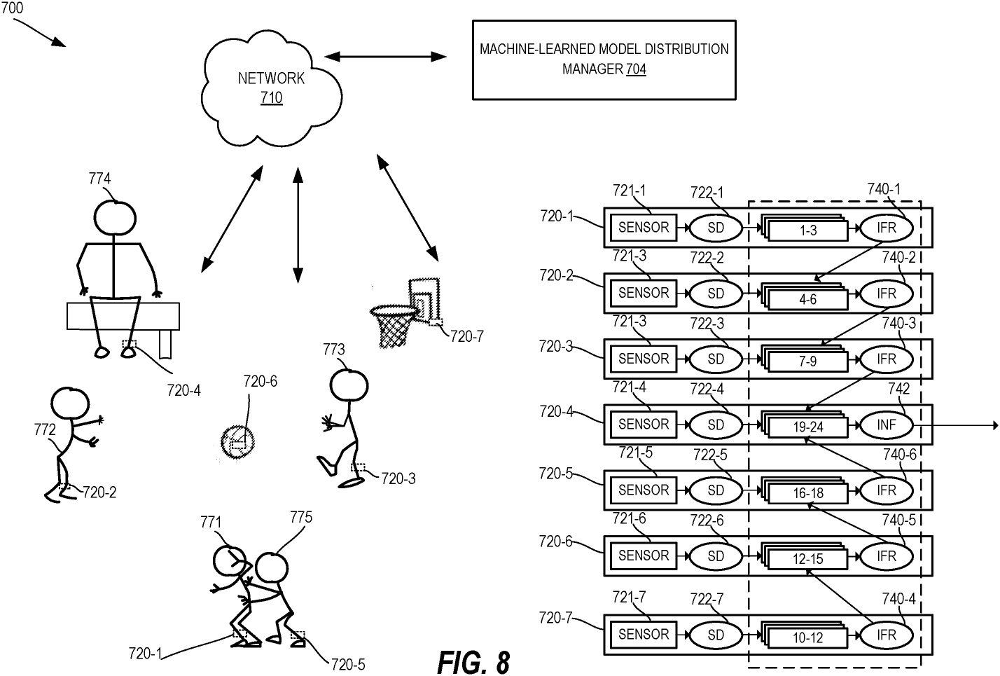

FIGS. 7 and 8 depict an example of a computing environment including the distribution of a machine-learned model across a set of interactive objects in accordance with example embodiment of the present disclosure. The set of interactive objects 720-1 to 720-7 and ML model distribution manager 704 can be in communication over one or more networks such as one or more mesh networks to permit direct communication between individual interactive objects of the set. FIG. 7 depicts a first distribution of machine-learned model 750 across the set of interactive objects 720-1 to 720-7 and FIG. 8 depicts a second distribution of the machine-learned model across the set of interactive objects. By way of example, FIG. 7 may represent an initial distribution of model 750 based on initial resource state information associated with the set of interactive objects and FIG. 8 may represent a redistribution of the model 750 in response to a change in resource state associated with at least one of the interactive objects of the set. As depicted in FIGS. 7 and 8, the set of interactive objects can execute a machine-learned model in order to detect movements based on sensor data associated with users during an activity in accordance with example embodiments of the present disclosure.

Interactive objects 720-1 to 720-5 are worn or otherwise disposed on a plurality of users 771 to 775, interactive object 720-6 is disposed on or within a ball 718, and interactive object 720-7 is disposed on or within a basketball backboard of a basketball hoop. Machine-learned model distribution manager 704 can identify the set of interactive objects to be used to generate sensor data so that inferences can be made by machine-learned model 750 during an activity in which the users are engaged. ML model distribution manager 704 can identify machine-learned model 750 as suitable for generating one or more inferences associated with the activity. In some examples, a user can provide input to one or more computing devices (e.g. one or more of the interactive objects or another computer device such as a smart phone, tablet, etc.) to identify an activity or inferences associated with an activity that they wish the system to identify. By way of example, a user facing application may be provided that enables a coach or other person to identify a set of wearable devices or other interactive objects, an activity, or provide other input in order to automatically trigger inference generation in association with an activity performed by the users. In some examples, ML model distribution manager 704 can automatically identify the set of interactive objects.

FIG. 7 illustrates a first or initial distribution of machine-learned model 750 across the set of interactive object 720-1 to 720-7. The initial distribution of the machine-learned model can be determined by ML model distribution manager 704 in example embodiments. The model distribution manager can identify one or more machine-learned models to be used to generate inferences associated with the activity and can determine the set of interactive objects that are each to be used to implement at least a portion of the machine-learned model during the activity. The set of interactive objects may include wearable devices worn by a group of users performing a sporting activity for example. For instance, the model distribution manager can determine a resource state associated with each of the interactive object 720-1 to 720-7. The resource state can be determined based on one or more resource attributes associated with each of interactive objects. The resource attributes may indicate computing, network, or other device resources available to the interactive object at a particular time. For example, one or more resource attributes may indicate an amount of power available to the interactive object, an amount of computing capacity available to the interactive object, an amount of bandwidth available to the interactive object, etc. The resource attributes may additionally or alternatively indicate an amount of current processing or other computing load associated with the interactive object.

The initial distribution illustrated in FIG. 7 may correspond to the beginning or prior to the commencement of an activity. For instance, ML model distribution manager 704 can initially distribute processing of the machine-learned model amongst the set of wearable devices based on an initial resource state associated with each of the interactive objects. The model distribution manager can determine resource attributes associated with each of the wearable devices. Based on the resource attributes associated with each of the wearable devices, the model distribution manager can determine respective portions of the machine-learned model for execution by each of the wearable devices.

The ML model distribution manager 704 can generate configuration data for each interactive object indicative or otherwise associated with the respective portion of the machine-learned model for such interactive object. The model distribution manager can communicate the configuration data to each wearable device. In response to the configuration data, each wearable device can configure at least a portion of the machine-learned model identified by the configuration data. In some examples, the configuration data can identify a particular portion of the machine-learned model to be executed by the interactive object. The configuration data can include one or more portions of the machine-learned model to be executed by the interactive object in some instances. It is noted that in other instances, the interactive object may already store a portion or all of the machine-learned model and/or may retrieve or otherwise obtain all or a portion of the machine-learned model. The configuration data can additionally or alternatively include weights for one or more layers of the machine-learned model, one or more feature projections for one or more layers of the machine-learned model, scheduling data for execution of one or more portions of the machine-learned model, an identification of inputs for the machine-learned model (e.g., local sensor data inputs and/or intermediate feature representations to be received from other interactive objects), and identification of outputs for the machine-learned model (e.g., computing devices to which inferences and/or intermediate representations are to be sent). Configuration data can include additional or alternative information in example embodiments.

For the initial distribution, ML model distribution manager 704 configures interactive object 720-1 through 720-6 to each execute three layers of machine-learned model 750. Machine-learned model distribution manager 704 configures interactive object 720-7 for execution of five layers of machine-learned model 750. ML model distribution manager 704 may determine that interactive object 720-7 has or will have greater resource availability during activity and therefore assigns a larger portion of the machine-learned model to such interactive object. Machine-learned model distribution manager 704 configures interactive object 720-1 with a first set of layers 1-3, interactive object 720-2 with a second set of layers 4-6, interactive object 720-3 with a third set of layers 7-9, interactive object 720-4 with a fourth set of layers 10-12, interactive object 720-5 with a fifth set of layers 13-15, and interactive object 720-6 with a sixth set of layers 16-18. Interactive object 720-7 is configured with a seventh set of layers 19-24. Machine-learned model distribution manager 704 can configure each of the interactive objects with the proper inputs and outputs to implement the causal system created by machine-learned model 750. For example, ML model distribution manager 704 can transmit configuration data to each of the interactive objects specifying the location of one or more inputs for the machine-learned model at the respective interactive object, as well as one or more outputs to which intermediate future representations and/or inferences should be sent.

Interactive object 720-1 can generate sensor data 722-1 from one or more sensors 721. Sensor data 722-1 can be provided as an input to layers 1-3 of machine-learned model 750. Layers 1-3 can generate one or more intermediate feature representations 740-1. Based on the configuration data from ML model distribution manager 704, interactive object 720-1 can transmit feature representations 740-1 to interactive object 720-2. Interactive object 720-2 can generate sensor data 722-2 from one or more sensors 721-2. Sensor data 722-2 can be provided as an input to layers 4-6 of machine-learned model 750. Additionally, intermediate feature representations 740-1 can be provided as an input to layers 4-6 at interactive object 720-2. Interactive object 720-2 can generate one or more intermediate feature representations 740-2 based on the sensor data generated locally as well as the intermediate feature representations generated by interactive object 720-1. Processing of the sensor data from the various interactive objects can proceed according to the configuration data provided by the ML model distribution manager. The causal processing continues as indicated in FIG. 7 until the intermediate feature representations 740-6 are provided to layers 19-24 at interactive object 720-7. Interactive object 720-7 generates sensor data 722-7 from one or more sensors 721-7. The sensor data and intermediate feature representations 740-6 are provided as input to layers 19-24. Based on the sensor data and intermediate feature representations, interactive object 720-7 can generate one or more inferences 742 that represent a determination based on the combination of sensor data from each of the interactive objects. For example, the one or more inferences 742 can indicate a classification of a movement or other motion to be classified by the machine-learned model.

FIG. 8 depicts an example redistribution of machine-learned model 750 by ML model distribution manager 704. In the example of FIG. 8, user 774 has transitioned from engagement in the activity performed by the other users to a restful position, such as by sitting. ML model distribution manager 704 may detect updated resource state information in association with interactive object 720-4 in response to the user transitioning to a restful position. For example, ML model distribution manager 704 may obtain updated resource state information indicating one or more resource attributes associated with interactive object 720-4 indicating additional resource availability. For example, the updated resource state information may indicate that interactive object 720-4 is performing less computational processing in response to the reduced motion by user 771. In response to detecting the updated resource state information associated with the set of interactive objects, the ML model distribution manager 704 can redistribute one or more portions of the machine-learned model to advantageously utilize the additional computing resources that are available.

For the example redistribution, ML model distribution manager 704 configures interactive objects 720-1 to 720-3 and 720-5 to 720-7 to each execute three layers of machine-learned model 750. Machine-learned model distribution manager 704 configures interactive object 720-4 for execution of five layers of machine-learned model 750. Machine-learned model distribution manager 704 configures interactive object 720-1 with a first set of layers 1-3, interactive object 720-2 with a second set of layers 4-6, interactive object 720-3 with a third set of layers 7-9, interactive object 720-7 with a fourth set of layers 10-12, interactive object 720-6 with a fifth set of layers 13-15, and interactive object 720-5 with a sixth set of layers 16-18. Interactive object 720-4 is configured with a seventh set of layers 19-24. Machine-learned model distribution manager 704 can configure each of the interactive objects with the proper inputs and outputs to maintain the causal system defined by machine-learned model 750. For example, machine-learned model distribution manager 704 can transmit configuration data to each of the interactive object specifying the location of one or more inputs for the machine-learned model at the respective interactive object, as well as one or more outputs to which intermediate future representations and/or inferences should be sent.

In accordance with the updated configuration data, sensor data 722-1 can be provided as an input to layers 1-3 of machine-learned model 750. Layers 1-3 can generate one or more intermediate feature representations 740-1. Interactive object 720-1 can transmit feature representations 740-1 to interactive object 720-2. Interactive object 720-2 can generate sensor data 722-2 which can be provided as an input to layers 4-6 along with intermediate feature representations 740-1. Interactive object 720-2 can generate one or more intermediate feature representations 740-2 based on the sensor data generated locally as well as the intermediate feature representations generated by interactive object 720-1. Interactive object 720-2 can transmit feature representations 740-2 to interactive object 720-3. Interactive object 720-3 can generate sensor data 722-3 which can be provided as an input to layers 7-9 along with intermediate feature representations 740-2. Interactive object 720-3 can generate one or more intermediate feature representations 740-3 based on the sensor data and intermediate feature representations 740-2. Interactive object 720-3 can transmit feature representations 740-3 to interactive object 720-4. Interactive object 720-7 can generate sensor data 722-7 which can be provided as an input to layers 10-12. Interactive object 720-7 can generate one or more intermediate feature representations 740-7 based on the sensor data. Interactive object 720-6 can generate sensor data 722-6 which can be provided as an input to layers 12-15 along with intermediate feature representations 740-7. Interactive object 720-6 can generate one or more intermediate feature representations 740-6 based on the sensor data and intermediate feature representations 740-7. Interactive object 720-5 can generate sensor data 722-5 which can be provided as an input to layers 16-18 with intermediate feature representations 740-6. Interactive object 720-5 can generate one or more intermediate feature representations 740-5 based on the sensor data and intermediate feature representations 740-5. Interactive object 720-4 can generate sensor data 722-4 which can be provided as an input to layers 19-24 along with intermediate feature representations 740-3 from interactive object 720-3 and intermediate feature representations 740-5 from interactive object 720-5. Interactive object 720-4 can generate one or more inferences 742 based on sensor data 722-4, intermediate feature representations 740-3, and intermediate feature representations 740-5.

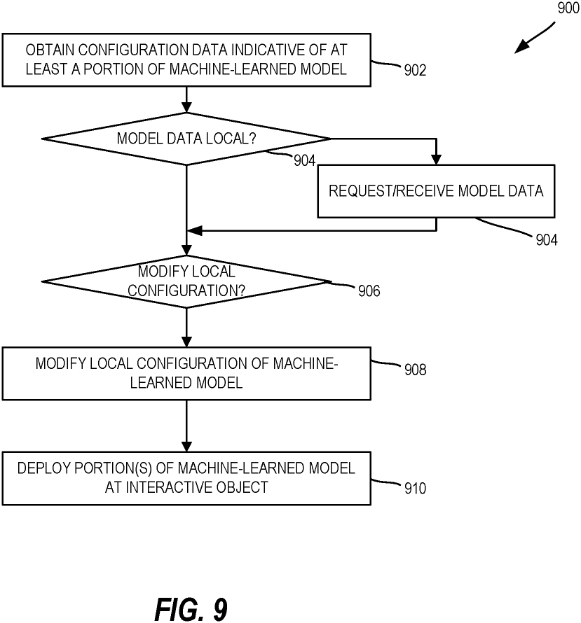

FIG. 9 depicts a flowchart describing an example method of configuring an interactive object in response to configuration data associated with a machine-learned model in accordance with example embodiments of the present disclosure. Method 900 can be performed locally by an interactive object in response to configuration data received from an ML model distribution manager in example embodiments.

At 902, method 900 includes obtaining configuration data indicative of at least a portion of a machine-learned model to be configured at an interactive object. The configuration data may include an identification of one or more portions of the machine-learned model. In some examples, the configuration data may include the actual portions of the machine-learned model.

At 904, method 900 includes determining whether the one or more portions of the machine-learned model are stored locally by the interactive object. For example, an interactive object may store all or a portion of the machine-learned model prior to commencement of activity which inferences will be generated. In other examples, an interactive object may not store any of the machine-learned model.

Method 900 continues at 904 if the interactive object does not store the one or more portions of the machine-learned model locally. At 904, method 900 can include requesting and/or receiving the one or more portions of the machine-learned model identified by the configuration data. For example, the interactive object can issue one or more requests to one or more remote location to retrieve copies of the one or more portions of the machine-learned model.

After obtaining or determining that the interactive object already stores the one or more portions of the machine-learned model, method 900 continues at 906. At 906, method 900 includes determining whether a local configuration of the machine-learned model is to be modified in accordance with the configuration data. For example, the interactive object may determine whether it is already configured in accordance with the configuration data.

Method 900 continues at 908 if the local configuration of the machine-learned model is to be modified. At 908, method 900 includes modifying the local figuration of the machine-learned model at the interactive object. In some examples, the interactive object can configure the machine-learned model for processing using a particular set of model parameters based on the configuration data. For instance, the set of parameters can include layers, weights, function mappings, etc. that the interactive object uses for the machine-learned model locally during processing. The parameters can be modified in response to updated configuration data. The interactive object can perform various operations at 908 to configure the machine-learned model with a particular set of layers, inputs, output, function mapping, etc. based on the configuration data. By way of example, the interactive object may store one or more layers identified by the configuration data as well as one or more weights to be used by the layers of the machine-learned model. As another example, the interactive object can configure inputs to the one or more layers identified by the configuration data. For instance, the inputs may include data received locally from one or more sensors as well as data such as intermediate feature representations received remotely from one or more other interactive objects. Similarly, the interactive objects can configure outputs of the one or more layers of the machine-learned model. For instance, the interactive object may be configured to provide one or more outputs of the machine-learned model such as one or more intermediate feature representations to other interactive objects of the set of interactive objects.

After modifying the local configuration of the machine-learned model or determining that the local configuration does not need to be modified, method 900 can continue at 910. At 910, method 900 can include deploying the one or more portions of the machine-learned model at the interactive object. At 910, the interactive object can begin processing of sensor data and other intermediate feature representations according to the updated configuration.

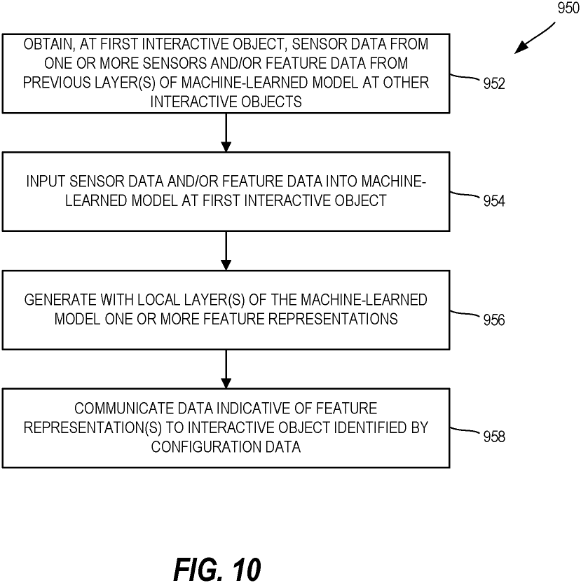

FIG. 10 depicts a flowchart describing an example method of machine-learned processing by an interactive object in accordance with example embodiments of the present disclosure. Method 950 can be performed locally by the interactive object to process sensor data and/or intermediate feature representations from other interactive object to generate additional feature representations and/or inferences based on sensor data and the feature representations.

At 952, method 950 can include obtaining at an interactive object sensor data from one or more sensors locally at interactive object. Additionally or alternatively, feature data such as one or more intermediate feature representations from previous layers of the machine-learned model executed by other interactive objects may be received.

At 954, method 950 can include inputting the sensor data and/or the feature data into one or more layers of the machine-learned model configured locally at the interactive object. In example embodiments, one or more residual networks may be utilized to combine feature representations with sensor data generated by different layers of a machine-learned model.

At 956, method 950 can include generating with one or more local layers of the machine-learned model at the interactive object, one or more feature representations and/or inferences. For example, if the local interactive object implements one or more intermediate layers of the machine-learned model, one or more intermediate feature representations can be generated for additional processing by additional layers of the machine-learned model. If, however, the local interactive object implements one or more final layers of the machine-learned model, one or more inferences can be generated.

At 958, method 950 can include communicating data indicative of the feature representations and/or inferences one or more remote computing devices. The one or more remote computing devices can include one or more other interactive object of set of interactive object the machine-learned model. For example, one or more intermediate feature representations can be transmitted to another interactive object for additional processing. As another example, the one or more remote computing devices can include other computing devices such as a tablet, smart phone, desktop, or cloud computing system. For example, one or more inferences can be transmitted to a remote computing device where they can be aggregated, further processed, and/or provided as output data within a graphical user interface.

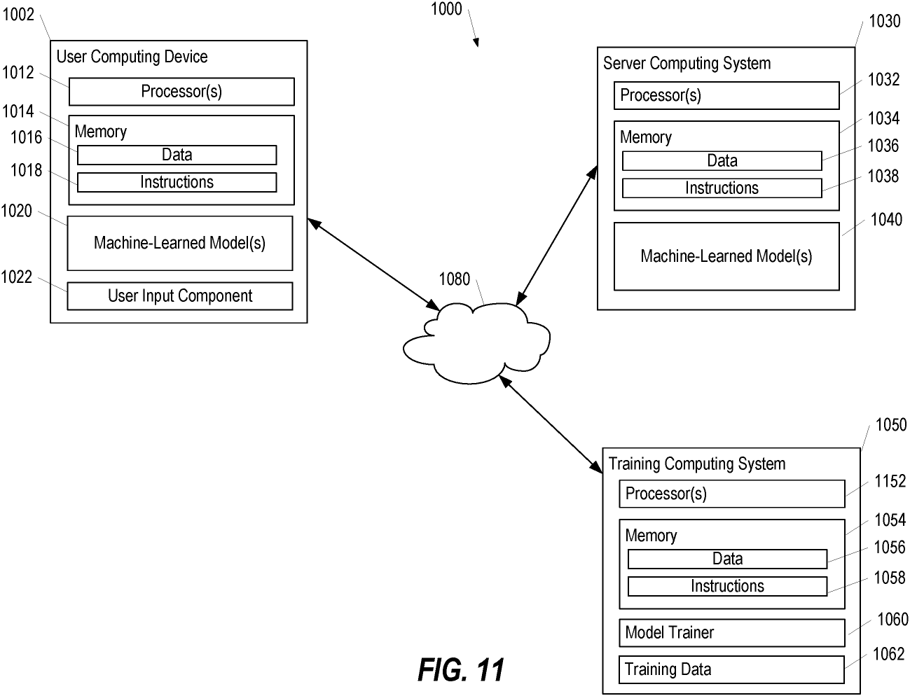

FIG. 11 depicts a block diagram of an example computing system 1000 that performs inference generation according to example embodiments of the present disclosure. The system 1000 includes a user computing device 1002, a server computing system 1030, and a training computing system 1050 that are communicatively coupled over a network 1080.

The user computing device 1002 can be any type of computing device, such as, for example, an interactive object, a personal computing device (e.g., laptop or desktop), a mobile computing device (e.g., smartphone or tablet), a gaming console or controller, a wearable computing device, an embedded computing device, or any other type of computing device.

The user computing device 1002 includes one or more processors 1012 and a memory 1014. The one or more processors 1012 can be any suitable processing device (e.g., a processor core, a microprocessor, an ASIC, a FPGA, a controller, a microcontroller, etc.) and can be one processor or a plurality of processors that are operatively connected. The memory 1014 can include one or more non-transitory computer-readable storage mediums, such as RAM, ROM, EEPROM, EPROM, flash memory devices, magnetic disks, etc., and combinations thereof. The memory 1014 can store data 1016 and instructions 1018 which are executed by the processor 1012 to cause the user computing device 1002 to perform operations.

The user computing device 1002 can include one or more portions of a distributed machine-learned model, such as one or more layers of a distributed neural network. The one or more portions of the machine-learned model can generate intermediate feature representations and/or perform inference generation such as gesture detection and/or movement recognition as described herein. Examples of the machine-learned model are shown in FIGS. 5, 7, and 8. However, systems other than the example system shown in these figures can be used as well.

In some implementations, the portions of the machine-learned model can store or include one or more portions of a gesture detection and/or movement recognition model. For example, the machine-learned model can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks.

Examples of distributed machine-learned models are discussed with reference to FIGS. 5, 7, and 8. However, the example models are provided by way of example only.

In some implementations, the one or more portions of the machine-learned model can be received from the server computing system 1030 over network 1080, stored in the user computing device memory 1014, and then used or otherwise implemented by the one or more processors 1012. In some implementations, the user computing device 1002 can implement multiple parallel instances of a machine-learned model (e.g., to perform parallel inference generation across multiple instances of sensor data).

Additionally or alternatively to the portions of the machine-learned model at the user computing device, the server computing system 1030 can include one or more portions of the machine-learned model. The portions of the machine-learned model can generate intermediate feature representations and/or perform inference generation as described herein. One or more portions of the machine-learned model can be included in or otherwise stored and implemented by the server computing system 130 (e.g., as a component of the machine-learned model) that communicates with the user computing device 1002 according to a client-server relationship. For example, the portions of the machine-learned model can be implemented by the server computing system 1030 as a portion of a web service (e.g., an image processing service). Thus, one or more portions can be stored and implemented at the user computing device 1002 and/or one or more portions can be stored and implemented at the server computing system 1030. The one or more portions at the server computing system can be the same as or similar to the one or more portions at the user computing device.

The user computing device 1002 can also include one or more user input components 1022 that receive user input. For example, the user input component 1022 can be a touch-sensitive component (e.g., a capacitive touch sensor 102) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 1030 includes one or more processors 1032 and a memory 1034. The one or more processors 1032 can be any suitable processing device (e.g., a processor core, a microprocessor, an ASIC, a FPGA, a controller, a microcontroller, etc.) and can be one processor or a plurality of processors that are operatively connected. The memory 1034 can include one or more non-transitory computer-readable storage mediums, such as RAM, ROM, EEPROM, EPROM, flash memory devices, magnetic disks, etc., and combinations thereof. The memory 1034 can store data 1036 and instructions 1038 which are executed by the processor 1032 to cause the server computing system 1030 to perform operations.

In some implementations, the server computing system 1030 includes or is otherwise implemented by one or more server computing devices. In instances in which the server computing system 1030 includes plural server computing devices, such server computing devices can operate according to sequential computing architectures, parallel computing architectures, or some combination thereof.

As described above, the server computing system 1030 can store or otherwise include one or more portions of the machine-learned model. For example, the portions can be or can otherwise include various machine-learned models. Example machine-learned models include neural networks or other multi-layer non-linear models. Example neural networks include feed forward neural networks, deep neural networks, recurrent neural networks, and convolutional neural networks. One example model is discussed with reference to FIGS. 5, 7, an d8.

The user computing device 1002 and/or the server computing system 1030 can train the machine-learned models 1020 and 1040 via interaction with the training computing system 1050 that is communicatively coupled over the network 1080. The training computing system 1050 can be separate from the server computing system 1030 or can be a portion of the server computing system 1030.

The training computing system 1050 includes one or more processors 1052 and a memory 1054. The one or more processors 1052 can be any suitable processing device (e.g., a processor core, a microprocessor, an ASIC, a FPGA, a controller, a microcontroller, etc.) and can be one processor or a plurality of processors that are operatively connected. The memory 1054 can include one or more non-transitory computer-readable storage mediums, such as RAM, ROM, EEPROM, EPROM, flash memory devices, magnetic disks, etc., and combinations thereof. The memory 1054 can store data 1056 and instructions 1058 which are executed by the processor 1052 to cause the training computing system 1050 to perform operations. In some implementations, the training computing system 1050 includes or is otherwise implemented by one or more server computing devices.

The training computing system 1050 can include a model trainer 1060 that trains a machine-learned model including portions stored at the user computing device 1002 and/or the server computing system 1030 using various training or learning techniques, such as, for example, backwards propagation of errors. In other examples as described herein, training computing system 1050 can train a machine-learned model (e.g., model 550 or 750) prior to deployment for provisioning of the machine-learned model at user computing device 1002 or server computing system 1030. The machine-learned model can be stored at training computing system 1050 for training and then deployed to user computing device 1002 and server computing system 1030. In some implementations, performing backwards propagation of errors can include performing truncated backpropagation through time. The model trainer 1060 can perform a number of generalization techniques (e.g., weight decays, dropouts, etc.) to improve the generalization capability of the models being trained.

In particular, the model trainer 1060 can train the models 1020 and 1040 based on a set of training data 1062. The training data 1062 can include, for example, a plurality of instances of sensor data, where each instance of sensor data has been labeled with ground truth inferences such as gesture detections and/or movement recognitions. For example, the label(s) for each training image can describe the position and/or movement (e.g., velocity or acceleration) of a touch input or an object movement. In some implementations, the labels can be manually applied to the training data by humans. In some implementations, the models can be trained using a loss function that measures a difference between a predicted inference and a ground-truth inference. In implementations which include multiple portions of a single model, the portions can be trained using a combined loss function that combines a loss at each portion. For example, the combined loss function can sum the loss from a portion with the loss from a another portion to form a total loss. The total loss can be backpropagated through the model.

In some implementations, if the user has provided consent, the training examples can be provided by the user computing device 1002. Thus, in such implementations, the model 1020 provided to the user computing device 1002 can be trained by the training computing system 1050 on user-specific data received from the user computing device 1002. In some instances, this process can be referred to as personalizing the model.

The model trainer 1060 includes computer logic utilized to provide desired functionality. The model trainer 1060 can be implemented in hardware, firmware, and/or software controlling a general purpose processor. For example, in some implementations, the model trainer 160 includes program files stored on a storage device, loaded into a memory and executed by one or more processors. In other implementations, the model trainer 1060 includes one or more sets of computer-executable instructions that are stored in a tangible computer-readable storage medium such as RAM hard disk or optical or magnetic media.

The network 1080 can be any type of communications network, such as a local area network (e.g., intranet), wide area network (e.g., Internet), or some combination thereof and can include any number of wired or wireless links. In general, communication over the network 1080 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

Figure 1110 illustrates one example computing system that can be used to implement the present disclosure. Other computing systems can be used as well. For example, in some implementations, the user computing device 1002 can include the model trainer 1060 and the training data 1062. In such implementations, the models 1020 can be both trained and used locally at the user computing device 1002. In some of such implementations, the user computing device 1002 can implement the model trainer 1060 to personalize the model 1020 based on user-specific data.

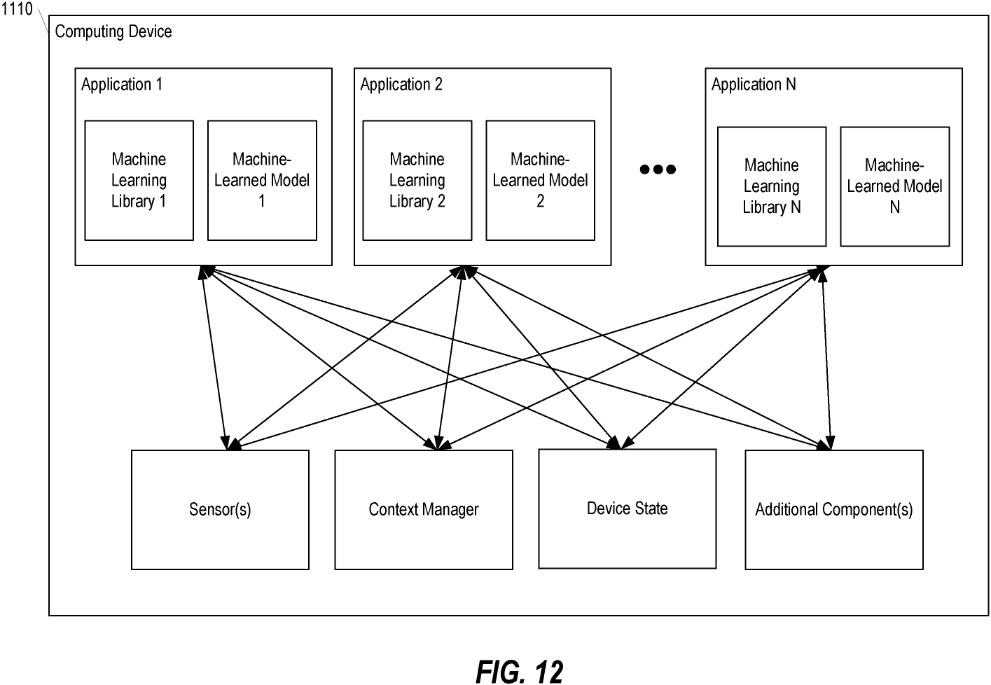

FIG. 12 depicts a block diagram of an example computing device 1110 that performs according to example embodiments of the present disclosure. The computing device 1110 can be a user computing device or a server computing device.

The computing device 1110 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 12, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

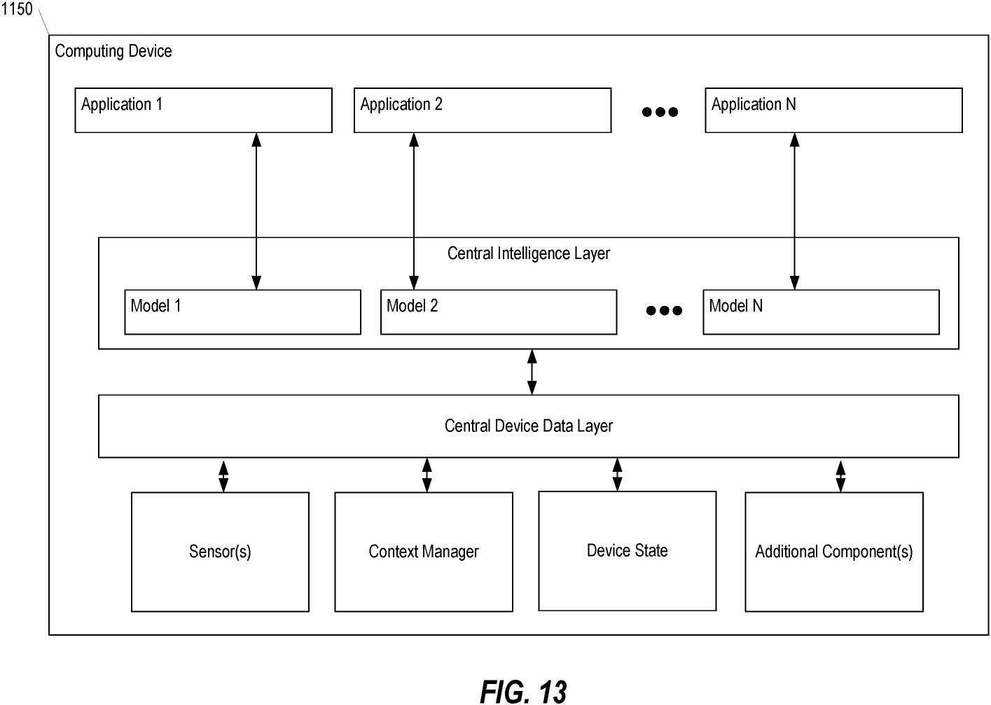

FIG. 13 depicts a block diagram of an example computing device 1150 that performs according to example embodiments of the present disclosure. The computing device 1150 can be a user computing device or a server computing device.

The computing device 1150 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 13, a respective machine-learned model (e.g., a model) can be provided for each application and managed by the central intelligence layer. In other implementations, two or more applications can share a single machine-learned model. For example, in some implementations, the central intelligence layer can provide a single model (e.g., a single model) for all of the applications. In some implementations, the central intelligence layer is included within or otherwise implemented by an operating system of the computing device 1150.

The central intelligence layer can communicate with a central device data layer. The central device data layer can be a centralized repository of data for the computing device 1150. As illustrated in FIG. 12, the central device data layer can communicate with a number of other components of the computing device, such as, for example, one or more sensors, a context manager, a device state component, and/or additional components. In some implementations, the central device data layer can communicate with each device component using an API (e.g., a private API).

The technology discussed herein makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, server processes discussed herein may be implemented using a single server or multiple servers working in combination. Databases and applications may be implemented on a single system or distributed across multiple systems. Distributed components may operate sequentially or in parallel.

While the present subject matter has been described in detail with respect to specific example embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

1. A computer-implemented method, comprising:
identifying, by at least one computing device of a computing system, a set of interactive objects to implement a machine-learned model for monitoring an activity while communicatively coupled over one or more networks, each interactive object including at least one respective sensor configured to generate sensor data associated with such interactive object, the machine-learned model configured to generate data indicative of at least one inference associated with the activity based at least in part on sensor data associated with two or more interactive objects of the set of interactive objects;
determining, by the computing system and for each interactive object of the set of interactive objects, a respective portion of the machine-learned model for execution by such interactive object during at least a portion of the activity;
generating, by the computing system and for each interactive object, configuration data indicative of the respective portion of the machine-learned model for execution by such interactive object during at least the portion of the activity; and
communicating, by the computing system to each interactive object of the set of interactive objects, the configuration data indicative of the respective portion of the machine-learned model for execution by such interactive object.

2. The method of claim 1, further comprising:
monitoring, by the at least one computing device, a respective resource state associated with each interactive object of the set of interactive objects during the activity; and
re-distributing execution of portions of the machine-learned model to individual interactive objects of the set of interactive objects during the activity based at least in part on the respective resource state associated with each interactive object.

3. The method of claim 2, wherein determining for each interactive object of the set of interactive objects the respective portion of the machine-learned model for execution by such interactive object during at least a portion of the activity comprises:
determining a first respective portion of the machine-learned model for execution by a first interactive object and a second respective portion of the machine-learned model for execution by a second interactive object during a first time period of the activity;
generating first configuration data indicative of the first respective portion of the machine-learned model for execution by the first interactive object first and second configuration data indicative of the second respective portion of the machine-learned model for execution by the second interactive object during the first time period of the activity; and
communicating to the first interactive object the first configuration data indicative of the first respective portion of the machine-learned model for execution by the first interactive object and communicating to the second interactive object the second configuration data indicative of the second respective portion of the machine-learned model for execution by the second interactive object.

4. The method of claim 3, wherein re-distributing execution of portions of the machine-learned model to individual interactive objects of the set of interactive objects during the activity comprises:
determining that the first respective portion of the machine-learned model is to be executed by the second interactive object during a second time period of the activity;
generating configuration data indicative of the first respective portion of the machine-learned model for execution by the second interactive object during the second time period of the activity; and
communicating the configuration data indicative of the first respective portion of the machine-learned model for execution by the second interactive object during the second time period of the activity.

5. The method of claim 1, wherein:
the configuration data for a first interactive object identifies an output of a second interactive object including one or more feature representations to be used as an input to the respective portion of the machine-learned model at the first interactive object.

6. The method of claim 1, wherein:
the interactive object is configured, in response to the configuration data indicative of the respective portion of the machine-learned model, to obtain the respective portion of the machine-learned model from at least one computing device remote from the interactive object.

7. The method of claim 1, wherein:
the configuration data for at least one interactive object includes the respective portion of the machine-learned model.

8. The method of claim 1, wherein:
the at least one respective sensor of at least one interactive object includes an inertial measurement unit.

9. The method of claim 1, wherein:
the set of interactive objects include at least one wearable device and at least one non-wearable device.

10. The method of claim 1, wherein:
the one or more networks include at least one mesh network that permits direct communication between the interactive objects of the set of interactive objects.

11. A computing system, comprising:
one or more processors; and
one or more non-transitory computer-readable media that collectively store instructions that when executed by the one or more processors cause the one or more processors to perform operations, the operations comprising:
identifying a set of interactive objects to implement a machine-learned model for monitoring an activity while communicatively coupled over one or more networks, each interactive object including at least one respective sensor configured to generate sensor data associated with such interactive object, the machine-learned model configured to generate data indicative of at least one inference associated with the activity based at least in part on sensor data associated with two or more interactive objects of the set of interactive objects;
determining for each interactive object of the set of interactive objects a respective portion of the machine-learned model for execution by such interactive object during at least a portion of the activity;
generating for each interactive object configuration data indicative of the respective portion of the machine-learned model for execution by such interactive object during at least the portion of the activity; and
communicating to each interactive object of the set of interactive objects the configuration data indicative of the respective portion of the machine-learned model for execution by such interactive object.

12. The computing system of claim 11, wherein the operations further comprise:
monitoring a respective resource state associated with each interactive object during the activity; and
re-distributing execution of portions of the machine-learned model to individual interactive objects of the set of interactive objects during the activity based at least in part on the respective resource state associated with each interactive object.

13. The computing system of claim 12, wherein determining for each interactive object of the set of interactive objects the respective portion of the machine-learned model for execution by such interactive object during at least a portion of the activity comprises:
determining a first respective portion of the machine-learned model for execution by a first interactive object and a second respective portion of the machine-learned model for execution by a second interactive object during a first time period of the activity;
generating first configuration data indicative of the first respective portion of the machine-learned model for execution by the first interactive object first and second configuration data indicative of the second respective portion of the machine-learned model for execution by the second interactive object during the first time period of the activity; and
communicating the first configuration data indicative of the first respective portion of the machine-learned model for execution by the first interactive object and the second configuration data indicative of the second respective portion of the machine-learned model for execution by the second interactive object.

14. The computing system of claim 13, wherein re-distributing execution of portions of the machine-learned model to individual interactive objects of the set of interactive objects during the activity comprises:
determining that the first respective portion of the machine-learned model is to be executed by the second interactive object during a second time period of the activity;
generating configuration data indicative of the first respective portion of the machine-learned model for execution by the second interactive object during the second time period of the activity; and
communicating the configuration data indicative of the first respective portion of the machine-learned model for execution by the second interactive object during the second time period of the activity.

15. The computing system of claim 11, wherein:
the configuration data for a first interactive object identifies an output of a second interactive object including one or more feature representations to be used as an input to the respective portion of the machine-learned model at the first interactive object.

16. An interactive object, comprising:
one or more sensors configured to generate sensor data associated with a user of the interactive object; and
one or more processors communicatively coupled to the one or more sensors, the one or more processors configured to:
obtain first configuration data indicative of a first portion of a machine-learned model configured to generate data indicative of at least one inference associated with an activity monitored by a set of interactive objects including the interactive object, the set of interactive objects being communicatively coupled over one or more networks and each interactive object storing at least a portion of the machine-learned model during at least a portion of a time period associated with the activity;
configure, in response to the first configuration data, the interactive object to generate a first set of feature representations based at least in part on the first portion of the machine-learned model and sensor data associated with the one or more sensors of the interactive obj ect;
obtain, by the interactive object subsequent to generating the first set of feature representations, second configuration data indicative of a second portion of the machine-learned model; and
configure, in response to the second configuration data, the interactive object to generate a second set of feature representations based at least in part on the second portion of the machine-learned model and sensor data associated with the one or more sensors of the interactive obj ect.

17. The interactive object of claim 16, wherein:
the first configuration data is associated with one or more first layers of at least one neural network of the machine-learned model; and
the second configuration data is associated with one or more second layers of the at least one neural network of the machine-learned model.

18. The interactive object of claim 17, wherein the one or more processors are configured to:
generate the first set of feature representations using the one or more first layers of the at least one neural network of the machine-learned model; and
generate the second set of feature representations using the one or more second layers of the at least one neural network of the machine-learned model.

19. The interactive object of claim 16, wherein:
the machine-learned model includes at least one neural network including a first set of layers, a second set of layers, a third set of layers, and a fourth set of layers;
the first set of feature representations is generated using the first set of layers based on an output of the second set of layers, the second set of layers being implemented at a second interactive object of the set of interactive objects; and
the second set of feature representations is generated using the third set of layers based on an output of the fourth set of layers, the fourth set of layers being implemented at a third interactive object of the set of interactive objects.

20. The interactive object of claim 16, wherein:
the first configuration data identifies a second interactive object to which the first set of feature representations should be communicated; and
the second configuration data identifies a third interactive object to which the second set of feature representations should be communicated.
